(19) United States
(12) Patent Application Publication
(10) Pub. No.: US 2024/0392089 A1
(43) Pub. Date: Nov. 28, 2024

(54) CELLULOSE ACETATE FOAMS

(71) Applicant: Eastman Chemical Company, Kingsport, TN (US)

(72) Inventors: BETHANY MICHELLE ADEN, KINGSPORT, TN (US); GAURAV AMARPURI, Alpharetta, GA (US); GOLIATH BENIAH, YORK, PA (US); STEPHANIE KAY CLENDENNEN, KINGSPORT, TN (US); MICHAEL EUGENE DONELSON, KINGSPORT, TN (US); Yichen Fang, Piney Flats, TN (US); THILANGA PRABHASH LIYANA ARACHCHI, KINGSPORT, TN (US); STEVEN THOMAS PERRI, KINGSPORT, TN (US); WAYNE KEN SHIH, MARYSVILLE, WA (US)

(73) Assignee: Eastman Chemical Company, Kingsport, TN (US)

(21) Appl. No.: 18/688,507

(22) PCT Filed: Sep. 1, 2022
(86) PCT No.: PCT/US2022/042294

§ 371 Date: Mar. 1, 2024

Related U.S. Application Data
(60) Provisional application No. 63/260,890, filed on Sep. 3, 2021.

(51) Int. Cl. C08J 9/00; C08J 9/12

(52) U.S. Cl. CPC C08J 9/0066; C08J 9/0061; C08J 9/0085; C08J 9/12; C08J 2201/022; C08J 2205/044; C08J 2301/02

(57) ABSTRACT

A cellulose acetate foam having a density of less than 0.20 g/cm³ and an average foam cell size of less than 200 micrometers is disclosed. A foamable composition, a method for foaming a foam and articles including, prepared or formed from the foam are also described.

### FIELD OF THE INVENTION

The resent invention relates generally to the field of foams, more particularly foams and articles; methods for their manufacture; and foamable compositions.

### BACKGROUND OF THE INVENTION

There is a well-known global issue with waste disposal, particularly of large volume consumer products such as plastics or polymers that are not considered biodegradable within acceptable temporal limits. In one example, foamed materials that are useful in applications such as in insulating, sound proofing, and food and nonfood packaging, are often manufactured from polystyrene and similar plastics which are not biodegradable. Indeed, governmental authorities in some jurisdictions are implementing restrictions if not bans on polystyrene based foams. Consumer sentiment similarly trends away from use of non-biodegradable plastics when a suitable alternative is offered. As a result, industry leaders, brand owners, and retailers have made ambitious commitments to implement environmentally friendly packaging in the coming years.

Use of biodegradable and/or compostable materials in the manufacture of foams and foam articles, though highly desirable from an environmental perspective, must still demonstrate processing, performance and aesthetic characteristics on par with fossil-fuel based plastics if they are to replace such plastics as a raw material of choice in the manufacture of such articles. Foamable compositions may be used to manufacture foams and foam articles with a foam density and cell size that can translate to a desirable combination and balance of toughness, stiffness and flexibility as well as heat transfer control and water/vapor impermeability in the foam and the final article.

Cellulose acetate-based foams can be biodegradable and are being investigated as an alternative for polystyrene foams in various end-use applications. There remains, however, a need for cellulose acetate-based foams that have sufficiently low densities and low uniform cell size and good thermal and mechanical properties for a wide variety of applications and that that can be formed from foamable compositions that are robustly melt-processable on commercial extrusion and thermoforming equipment.

### SUMMARY OF THE INVENTION

In a first aspect, the present application discloses a cellulose acetate foam. The cellulose acetate foam of the present invention has a density of less than 0.20 g/cm³ and an average foam cell size of less than 200 micrometers. In one or more embodiments, the cellulose acetate foam may be formed from or prepared from a foamable composition including: (1) a cellulose acetate; (2) plasticizer; (3) a physical nucleating agent; and (4) a physical blowing agent. In one or embodiments, the foamable composition and/or the foam may be one or more of biodegradable, compostable and disintegrable.

In another aspect, the present application discloses a foamable composition. The foamable composition of the present invention includes: 1) a cellulose acetate having a degree of substitution of acetyl(DS_{Ac}) in the range of from 1.8 to 2.6; (2) 2 to 30 wt % of processing aid; (3) 0.5 to 6.0 wt % of nucleating agent selected from the group consisting a physical nucleating agent and a chemical nucleating agent and combinations thereof; and (4) 1.5 to 10.0 wt % of physical blowing agent, wherein the proportions of each component of the composition is based on the total weight of the foamable composition.

In yet another aspect, the present application discloses an article. The article of the present invention includes or is formed from or is prepared from a cellulose acetate foam, wherein the cellulose acetate foam has a density of less than 0.20 g/cm³ and an average foam cell size of less than 200 micrometers.

In still another aspect, the present application discloses a method for forming a foam. The method of the present invention includes the steps of (a) forming a melt of a melt-processable composition, said melt-processable composition including (1) a cellulose acetate; (2) a processing aid; and (3) a nucleating agent; (b) adding a physical blowing agent to said melt to form a foamable melt; and (c) extruding said foamable melt under conditions sufficient to form a foam therefrom, wherein said extrusion conditions include a melt temperature of from 120° C. to 210° C. and an extrusion pressure of from 20 to 250 bar. In one or more embodiments, the melt-processable composition includes (1) a cellulose acetate having a degree of substitution of acetyl(DS_{Ac}) in the range of from 1.8 to 2.6; (2) 2 to 30 wt % of processing aid; and (3) 0.5 to 6.0 wt % of nucleating agent selected from the group consisting a physical nucleating agent and a chemical nucleating agent and combinations thereof.

### DETAILED DESCRIPTION OF THE INVENTION

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

Nucleating agent means a chemical or physical material that provides sites for cells to form in a molten formulation mixture. Nucleating agents may be selected from the group consisting of chemical nucleating agents and physical nucleating agents. In one or more embodiments of the method described herein, a nucleating agent may be blended with a formulation that is introduced into the hopper of an extruder or, alternatively, may be added to a molten resin mixture or melt in the extruder.

Suitable physical nucleating agents have desirable particle geometries. In one or more embodiments, the physical nucleating agent has a median particle size of less than 2 microns or may be a particulate composition with a median particle size of less than 2 microns. Examples of physical nucleating agents include, but are not limited to, talc, a magnesium silicate, a silicon dioxide, a magnesium oxide, CaCO₃, mica, and mixtures of at least two of the foregoing. One representative example is a material commercially available from Heritage Plastics as HT6000 Linear Low Density Polyethylene (LLDPE) Based Talc Concentrate.

Suitable chemical nucleating agents may decompose to create cells in the molten formulation when a chemical reaction temperature is reached. These small cells act as nucleation sites for larger cell growth from a physical or other type of blowing agent. In one example, the chemical nucleating agent is citric acid or a citric acid-based material. One representative example is HYDROCEROL™ CF-40E (available from Clariant Corporation), which contains citric acid and a crystal nucleating agent.

An endothermic chemical nucleating agent is a combination of an acid, a base, dispersion aid, nucleating agent, and perhaps fillers. The combination of additives includes a carrier polymer that can be processed at low temperatures to minimize reactivity of the components prior to use during the foaming process. As the nucleating agent is heated in the foaming process, a gas is released to aid in foaming the polymer and also nucleates to produce uniform cell size. The gas is typically CO₂ but can also be N₂ and other gases useful for foaming. The most typical acid is citric acid but can be any number of acids beneficial to aid the reaction. Typical bases include various carbonates including sodium bicarbonate as well as other carbonates. In addition, the chemical nucleating agent can include other additives that promote dispersion. The carrier polymer can be any number of polymers that can be processed at low temperature below the decomposition temperatures of active ingredients and allow for effective mixing of the components and pelletizing, example include but are not limited to aliphatic polyesters, aliphatic/aromatic polyesters, polystyrene and olefins like polyethylene or polypropylene.

A blowing agent refers to a physical or a chemical material (or combination of materials) that acts to expand nucleation sites. Blowing agents may include chemical blowing agents, physical blowing agents, combinations thereof, or several types of chemical and physical blowing agents. The blowing agent may act to reduce density by forming cells in the molten formulation at the nucleation sites. The blowing agent may be added to a molten resin mixture, composition or melt in the extruder, for example by injection.

Chemical blowing agents are materials that degrade, decompose or react to produce a gas. Chemical blowing agents may be endothermic or exothermic. Chemical blowing agents typically degrade at a certain temperature to decompose and release gas. Examples of chemical blowing agents include citric acid, sodium bicarbonate, sodium carbonate, ammonium bicarbonate, ammonium carbonate, and the like.

Examples of physical blowing agents include N₂, CO₂, alkanes, alkenes, ethers, esters, ketones, argon, helium, air, water or mixtures thereof. In one or more embodiments, the physical blowing agent may be selected from the group consisting of one or more of CO₂, acetone, ethanol, isopropanol, ethyl acetate, water, Propane, Isobutane, n-pentane, and Isopentane and combinations thereof.

“Rᵣₘₛ Surface Roughness” refers to the root mean squared roughness of a surface, which measures the vertical deviations of a real surface from its ideal form. The roughness refers to surface micro-roughness which may be different than measurements of large-scale surface variations. Rᵣₘₛ surface roughness can be determined by using light profilometry.

In various interrelated aspects and embodiments, the present invention is directed to foams; methods for making foams; articles including, formed from or prepared from foams; and foamable compositions for making foams. One of ordinary skill will understand and appreciate that elements or features used to describe one aspect or embodiment may be applicable and useful in describing other embodiments. By way of non-limiting example, the description of a cellulose acetate set forth in the context of the cellulose acetate foam of the present invention is also applicable and useful in describing cellulose acetate in the context of articles formed from or prepared from foams, foamable compositions that include cellulose acetate and foam-making methods. Accordingly, descriptions and disclosure relating to elements or features of an aspect or embodiment of the present invention are hereby expressly relied on to describe and support those elements or features in other aspects or embodiments.

In a first aspect, the present invention is directed to a to a cellulose acetate foam. The cellulose acetate foam of the present invention has a density of less than 0.20 g/cm³ and an average foam cell size of less than 200 micrometers. In one or more embodiments, the cellulose acetate foam of the present invention has a density of less than 0.15 g/cm³ and an average foam cell size of less than 200 micrometers. In one or more embodiments, the cellulose acetate foam of the present invention has a density of less than 0.18 g/cm³ and an average foam cell size of less than 200 micrometers. In one or more embodiments, the foam is one or more of biodegradable, compostable and disintegrable.

In one or more embodiments, the cellulose acetate foam may have a density of from 0.03 to 0.18 g/cm³, 0.01 to 0.20 g/cm³ or 0.01 to 0.15 g/cm³, or 0.01 to 0.14 g/cm³, or 0.01 to 0.13 g/cm³, or 0.01 to 0.12 g/cm³, or 0.01 to 0.11 g/cm³, or 0.01 to 0.10 g/cm³, or 0.01 to 0.09 g/cm³, or 0.01 to 0.08 g/cm³, 0.01 to 0.07 g/cm³, or 0.03 to 0.15 g/cm³, or 0.03 to 0.14 g/cm³, or 0.03 to 0.13 g/cm³, or 0.03 to 0.12 g/cm³, or 0.03 to 0.11 g/cm³, or 0.03 to 0.10 g/cm³, or 0.03 to 0.09 g/cm³ or 0.03 to 0.08 g/cm³.

In one or more embodiments, the cellulose acetate foam may have an average foam cell size of from 40 micrometers to 200 micrometers or from 40 micrometers to 190 micrometers or from 40 micrometers to 180 micrometers or from 40 micrometers to 170 micrometers or from 40 micrometers to 160 micrometers or from 40 micrometers to 150 micrometers or from 40 micrometers to 140 micrometers or from 40 micrometers to 130 micrometers or from 40 micrometers to 120 micrometers or from 40 micrometers to 110 micrometers or from 40 micrometers to 100 micrometers or from 60 micrometers to 200 micrometers or from 60 micrometers to 190 micrometers or from 60 micrometers to 180 micrometers or from 60 micrometers to 170 micrometers or from 60 micrometers to 160 micrometers or from 60 micrometers to 150 micrometers or from 60 micrometers to 140 micrometers or from 60 micrometers to 130 micrometers or from 60 micrometers to 120 micrometers or from 60 micrometers to 110 micrometers or from 60 micrometers to 100 micrometers.

In one or more embodiments, the cellulose acetate foam of the present invention may be characterized by one or other features or parameters. In one or more embodiments, the cellulose acetate foam of the present invention Rᵣₘₛ Surface Roughness of surface area roughness of from 0.01 to 500 microns. “Rᵣₘₛ Surface Roughness” refers to the root mean squared roughness of a surface, which measures the vertical deviations of a real surface from its ideal form. The roughness refers to surface micro-roughness which may be different than measurements of larger-scale surface variations. Rims surface roughness can be determined by using light profilometry. In one or more embodiments, the cellulose acetate foam of the present invention may be characterized by Rms surface area roughness of from 0.05 to 500 microns, or 0.05 to 400 microns, or 0.05 to 300 microns, or 0.05 to 200 microns, or 0.05 to 100 microns, or 0.05 to 50 microns, or 0.05 to 250 microns, or 0.05 to 15 microns, or 0.05 to 10 microns, or 0.05 to 5 microns, or 0.1 to 500 microns, or 0.1 to 400 microns, or 0.1 to 300 microns, or 0.1 to 200 microns, or 0.1 to 100 microns, or 0.1 to 50 microns, or 0.1 to 250 microns, or 0.1 to 15 microns, or 0.1 to 10 microns, or 0.1 to 5 microns, or 0.5 to 500 microns, or 0.5 to 400 microns, or 0.5 to 300 microns, or 0.5 to 200 microns, or 0.5 to 100 microns, or 0.5 to 50 microns, or 0.5 to 250 microns, or 0.5 to 15 microns, or 0.5 to 10 microns, or 0.5 to 5 microns, or 1 to 500 microns, or 1 to 400 microns, or 1 to 300 microns, or 1 to 200 microns, or 1 to 100 microns, or 1 to 50 microns, or 1 to 250 microns, or 1 to 15 microns, or 1 to 10 microns, or 1 to 5 microns, or 5 to 500 microns, or 5 to 400 microns, or 5 to 300 microns, or 5 to 200 microns, or 5 to 100 microns, or 5 to 50 microns, or 5 to 250 microns, or 5 to 15 microns, or 5 to 10 microns, or 10 to 500 microns, or 10 to 400 microns, or 10 to 300 microns, or 10 to 200 microns, or 10 to 100 microns, or 10 to 50 microns, or 10 to 25 microns, or 10 to 15 microns, or 15 to 500 microns, or 15 to 400 microns, or 15 to 300 microns, or 15 to 200 microns, or 15 to 100 microns, or 15 to 50 microns, or 15 to 25 microns, or 20 to 500 microns, or 20 to 400 microns, or 20 to 300 microns, or 20 to 200 microns, or 20 to 100 microns, or 20 to 50 microns, or 20 to 25 microns, or 30 to 500 microns, or 30 to 400 microns, or 30 to 300 microns, or 30 to 200 microns, or 30 to 100 microns, or 30 to 50 microns, or 40 to 500 microns, or 40 to 400 microns, or 40 to 300 microns, or 40 to 200 microns, or 40 to 100 microns, or 40 to 50 microns, or 60 to 500 microns, or 60 to 400 microns, or 60 to 300 microns, or 60 to 200 microns, or 60 to 100 microns, or 80 to 500 microns, or 80 to 400 microns, or 80 to 300 microns, or 80 to 200 microns, or 80 to 100 microns, or 100 to 500 microns, or 100 to 400 microns, or 100 to 300 microns, or 100 to 200 microns, or 200 to 500 microns, or 200 to 400 microns, or 200 to 300 microns, or 300 to 500 microns, or 300 to 400 microns, or 400 to 500 microns.

In one embodiment or in combination with any other embodiment, the cellulose acetate foam further comprises a processing aid. In one class of this embodiment or in combination with any class within this embodiment, the processing aid is present at from 2 to 30 wt %, based on the total weight of the foam. In one class of this embodiment or in combination with any class within this embodiment, the processing aid is a plasticizer selected from the group consisting of one or more of triacetin, triethyl citrate and polyethylene glycol having an average weight average molecular weight of from 200 to 1000 Da.

In one embodiment or in combination with any other embodiment, the foam further comprises a biodegradable filler. In one class of this embodiment or in combination with any class within this embodiment, the biodegradable filler comprises hemp, agave, bagasse, bast, jute, flax, ramie, kenaf, sisal, bamboo, or wood cellulose fibers. In one class of this embodiment or in combination with any class within this embodiment, the biodegradable filler is a natural filler. A natural filler is a ground plant derived particle composition that is free flowing. Examples of natural fillers include ground particle compositions of cork, grain fiber or bran (e.g., oat fiber, oat bran, wheat bran, rice bran, rice hull), nut shell (e.g., walnut shell, pecan shell, coconut shell, hazelnut shell, macadamia nut shell, Brazil nut shell, chestnut shell, almond shell), or stone fruit pit (e.g., apricot pit, peach pit, nectarine pit, olive pit, cherry pit, date pit, plum pit, palm kernel pit).

In one embodiment or in combination with any other embodiment, the foam comprises two or more cellulose acetates having different degrees of substitution of acetyl(DS_{Ac}).

In one embodiment or in combination with any other embodiment, the foam further comprises a biodegradable polymer which is chosen from a polyhydroxylalkanoate (“PHA”), a polylactic acid (“PLA”), a polycaprolactone (“PCL”), a polybutylene succinate (“PBS”), a polybutylene adipate terephthalate (“PBAT”), a cellulose mixed ester, a cellulose ether, a starch, a protein, or combinations thereof. In one class of this embodiment, the biodegradable polymer is present at from 0.1 to 50 wt % based on the total weight of the foam.

In one or more embodiments, the cellulose acetate foam of the present invention may be formed from or prepared from a foamable composition that includes: (1) a cellulose acetate; (2) plasticizer; (3) physical nucleating agent; and (4) physical blowing agent. In certain embodiments, the foamable composition without the blowing agent, or a composition including (1) a cellulose acetate; (2) plasticizer; and (3) physical nucleating agent, may be referred to a melt-processable composition or a blowing agent composition precursor. In one or more embodiments, the cellulose acetate foam of the present invention may be formed from or prepared from a foamable composition that includes: (1) a cellulose acetate having a degree of substitution of acetyl(DS_{Ac}) in the range of from 1.8 to 2.6; (2) 2 to 30 wt % of processing aid; (3) 0.5 to 6.0 wt % of nucleating agent selected from the group consisting a physical nucleating agent and a chemical nucleating agent and combinations thereof; and (4) 1.5 to 10.0 wt % of physical blowing agent, wherein the proportions of each component of the composition is based on the total weight of the foamable composition; wherein the proportions of each component of the composition is based on the total weight of the foamable composition. The foamable composition is typically melt-processable. The foamable composition may be one or more of biodegradable, compostable and disintegrable.

In one or more embodiments, the cellulose acetate is present in the foamable composition in an amount of from 50% to 97% by weight or from 55% to 95% by weight or from 60% to 90% of from 65% to 85% by weight based on the total weight of the melt-processable, cellulose acetate composition. The cellulose acetate useful in the present invention can be any that is known in the art and that is preferably biodegradable. Cellulose acetate that can be used for the present invention generally comprise repeating units of the structure:

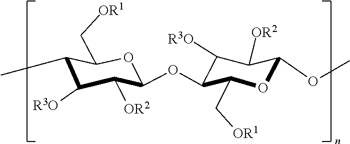

wherein R¹, R², and R³ are selected independently from the group consisting of hydrogen or acetyl. For cellulose esters, the substitution level is usually express in terms of degree of substitution (DS), which is the average number of non-OH substituents per anhydroglucose unit (AGU). Generally, conventional cellulose contains three hydroxyl groups in each AGU unit that can be substituted; therefore, DS can have a value between zero and three. Native cellulose is a large polysaccharide with a degree of polymerization from 250-5,000 even after pulping and purification, and thus the assumption that the maximum DS is 3.0 is approximately correct. Because DS is a statistical mean value, a value of 1 does not assure that every AGU has a single substituent. In some cases, there can be unsubstituted anhydroglucose units, some with two and some with three substitutents, and typically the value will be a non-integer. Total DS is defined as the average number of all of substituents per anhydroglucose unit. The degree of substitution per AGU can also refer to a particular substituent, such as, for example, hydroxyl or acetyl. In embodiments, n is an integer in a range from 25 to 250, or 25 to 200, or 25 to 150, or 25 to 100, or 25 to 75.

In embodiments of the invention, the cellulose acetates have at least 2 anhydroglucose rings and can have between at least 50 and up to 5,000 anhydroglucose rings, or at least 50 and less than 150 anhydroglucose rings. The number of anhydroglucose units per molecule is defined as the degree of polymerization (DP) of the cellulose acetate. In embodiments, cellulose esters can have an inherent viscosity (IV) of about 0.2 to about 3.0 deciliters/gram, or about 0.5 to about 1.8, or about 1 to about 1.5, as measured at a temperature of 25° C. for a 0.25 gram sample in 100 ml of a 60/40 by weight solution of phenol/tetrachloroethane. In embodiments, cellulose acetates useful herein can have a DS/AGU of about 1 to about 2.5, or 1 to less than 2.2, or 1 to less than 1.5, and the substituting ester is acetyl.

Cellulose acetates can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose acetates, can be obtained in different grades and sources such as from cotton linters, softwood pulp, hardwood pulp, corn fiber and other agricultural sources, and bacterial cellulose, among others.

One method of producing cellulose acetates is esterification of the cellulose by mixing cellulose with the appropriate organic acids, acid anhydrides, and catalysts. Cellulose is then converted to a cellulose triester. Ester hydrolysis is then performed by adding a water-acid mixture to the cellulose triester, which can then be filtered to remove any gel particles or fibers. Water is then added to the mixture to precipitate the cellulose ester. The cellulose ester can then be washed with water to remove reaction by-products followed by dewatering and drying.

The cellulose triesters to be hydrolyzed can have three acetyl substituents. These cellulose esters can be prepared by a number of methods known to those skilled in the art. For example, cellulose esters can be prepared by heterogeneous acylation of cellulose in a mixture of carboxylic acid and anhydride in the presence of a catalyst such as H2SO4. Cellulose triesters can also be prepared by the homogeneous acylation of cellulose dissolved in an appropriate solvent such as LiCl/DMAc or LiCl/NMP.

Those skilled in the art will understand that the commercial term of cellulose triesters also encompasses cellulose esters that are not completely substituted with acyl groups. For example, cellulose triacetate commercially available from Eastman Chemical Company, Kingsport, TN, U.S.A., typically has a DS from about 2.85 to about 2.99.

After esterification of the cellulose to the triester, part of the acyl substitutents can be removed by hydrolysis or by alcoholysis to give a secondary cellulose ester. As noted previously, depending on the particular method employed, the distribution of the acyl substituents can be random or non-random. Secondary cellulose esters can also be prepared directly with no hydrolysis by using a limiting amount of acylating reagent. This process is particularly useful when the reaction is conducted in a solvent that will dissolve cellulose. All of these methods yield cellulose esters that are useful in this invention.

In one embodiment or in combination with any of the mentioned embodiments, or in combination with any of the mentioned embodiments, the cellulose acetates are cellulose diacetates that have a polystyrene equivalent number average molecular weight (Mn) from about 10,000 to about 100,000 as measured by gel permeation chromatography (GPC) using NMP as solvent and polystyrene equivalent Mn according to ASTM D6474. In embodiments, the cellulose acetate comprises cellulose diacetate having a polystyrene equivalent number average molecular weights (Mn) from 10,000 to 90,000; or 10,000 to 80,000; or 10,000 to 70,000; or 10,000 to 60,000; or 10,000 to less than 60,000; or 10,000 to less than 55,000; or 10,000 to 50,000; or 10,000 to less than 50,000; or 10,000 to less than 45,000; or 10,000 to 40,000; or 10,000 to 30,000; or 20,000 to less than 60,000; or 20,000 to less than 55,000; or 20,000 to 50,000; or 20,000 to less than 50,000; or 20,000 to less than 45,000; or 20,000 to 40,000; or 20,000 to 35,000; or 20,000 to 30,000; or 30,000 to less than 60,000; or 30,000 to less than 55,000; or 30,000 to 50,000; or 30,000 to less than 50,000; or 30,000 to less than 45,000; or 30,000 to 40,000; or 30,000 to 35,000; as measured by gel permeation chromatography (GPC) using NMP as solvent and according to ASTM D6474.

The most common commercial secondary cellulose esters are prepared by initial acid catalyzed heterogeneous acylation of cellulose to form the cellulose triester. After a homogeneous solution in the corresponding carboxylic acid of the cellulose triester is obtained, the cellulose triester is then subjected to hydrolysis until the desired degree of substitution is obtained. After isolation, a random secondary cellulose ester is obtained. That is, the relative degree of substitution (RDS) at each hydroxyl is roughly equal.

The cellulose acetates useful in the present invention can be prepared using techniques known in the art and can be chosen from various types of cellulose esters, such as for example the cellulose esters that can be obtained from Eastman Chemical Company, Kingsport, TN, U.S.A., including without limitation Eastman™ Cellulose Acetates CA 398-30, CA 398-10, CA 394-60S and CA 394-LS.

In embodiments of the invention, the cellulose acetate can be prepared by converting cellulose to a cellulose ester with reactants that are obtained from recycled materials, e.g., a recycled plastic content syngas source. In embodiments, such reactants can be cellulose reactants that include organic acids and/or acid anhydrides used in the esterification or acylation reactions of the cellulose, e.g., as discussed herein.

In one or more embodiments of the present invention, the cellulose acetate has a degree of substitution of acetyl(DS_{Ac}) in the range of from 1.8 to 2.6 or from 2.0 to 2.6 or from 2.2 to 2.6.

In one or more embodiments, the cellulose acetate may include at least one recycle cellulose acetate. “Recycle cellulose acetate” is intended to include a cellulose acetate that has at least one substituent on an anhydroglucose unit (AU) derived from recycled content material, e.g., recycled plastic content syngas.

In one or more embodiments, the present invention is directed to a cellulose acetate foam with a density of less than 0.15 g/cm³ and an average foam cell size of less than 200 micrometers, wherein the cellulose acetate foam is prepared from or formed from a foamable composition comprising: (1) a cellulose acetate; (2) a processing aid which is a plasticizer; (3) a physical nucleating agent; and (4) a physical blowing agent. In one or more embodiments, the cellulose acetate foam may have a density of less than 0.15 g/cm³ and an average foam cell size of less than 200 micrometers and may be formed from or prepared from a foamable composition that includes: (1) a cellulose acetate having a degree of substitution of acetyl(DS_{Ac}) in the range of from 1.8 to 2.6; (2) 2 to 30 wt % of processing aid; (3) 0.5 to 6.0 wt % of nucleating agent selected from the group consisting a physical nucleating agent and a chemical nucleating agent and combinations thereof; and (4) 1.5 to 10.0 wt % of physical blowing agent, wherein the proportions of each component of the composition is based on the total weight of the foamable composition. A more detailed description regarding the foamable composition per se is set forth below as a separate aspect, and the features and elements therein expressly support and describe this present aspect in one or more embodiments; however, one of ordinary skill will appreciate that a number of compositional and processing factors may influence foam features such as density and cell size.

In another aspect, the present invention is directed to a foamable composition. The foamable composition of the present invention generally includes: (1) a cellulose acetate; (2) plasticizer; (3) physical nucleating agent; and (4) physical blowing agent. In one or more embodiments, the foamable composition of the present invention includes 1) a cellulose acetate having a degree of substitution of acetyl(DS_{Ac}) in the range of from 1.8 to 2.6; (2) 2 to 30 wt % of processing aid; (3) 0.5 to 6.0 wt % of nucleating agent selected from the group consisting a physical nucleating agent and a chemical nucleating agent and combinations thereof; and (4) 1.5 to 10.0 wt % of physical blowing agent, wherein the proportions of each component of the composition is based on the total weight of the foamable composition.

The foamable composition of the present invention includes (in addition to the cellulose acetate described elsewhere herein) includes processing aid. The phrase “processing aid” as used herein is intended to generally include materials that aid in the melt processability of the composition in melt form such as typically employed in foam formation processes. The processing aid is present in an amount sufficient to permit the foamable composition to be melt processed (or thermally formed) into useful articles, e.g., single use plastic articles, in conventional melt processing equipment, and that amount is referred to as a “melt-processing amount”. The phrase “melt-processing amount” includes amounts of processing aid that are sufficient to render the cellulose acetate present in the foamable composition capable of forming a melt and melt processing into useful articles. One of ordinary skill will appreciate that the specific amount of processing aid that may constitute a “melt-processing amount” may depend on a number of factors such as for example cellulose acetate selection and amount as well as selection, amount and identity of additives present in the foamable composition.

In one or more embodiments, the processing aid includes plasticizer. The plasticizer reduces the melt temperature, the Tg, and/or the melt viscosity of the cellulose acetate. In embodiments, the plasticizer is a food-compliant plasticizer. By food-compliant is meant compliant with applicable food additive and/or food contact regulations where the plasticizer is cleared for use or recognized as safe by at least one (national or regional) food safety regulatory agency (or organization), for example listed in the 21 CFR Food Additive Regulations or otherwise Generally Recognized as Safe (GRAS) by the US FDA. In embodiments, the food-compliant plasticizer is triacetin. In embodiments, non-limiting examples of food-compliant plasticizers include triacetin, triethyl citrate, polyethylene glycols (such as PEG 400), Benzoflex, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycerol tribenzoate. In one or more embodiments, the plasticizer comprises triacetin, triethyl citrate, or a polyethylene glycol having an average weight average molecular weight of from 300 to 1000 Da. In one class of this embodiment, the plasticizer comprises triacetin. In one class of this embodiment, the plasticizer comprises triethyl citrate. In one class of this embodiment, the plasticizer comprises a polyethylene glycol having an average weight average molecular weight of from 300 to 1000 Da. In one subclass of this class the polyethylene glycol has an average weight average molecular weight of from 300 to 500 Da. In one subclass of this class the polyethylene glycol has an average weight average molecular weight of 400 Da.

In embodiments, the plasticizer is present in an amount sufficient to permit the foamable composition to be melt processed (or thermally formed) into useful articles, e.g., single use plastic articles, in conventional melt processing equipment, and that amount is referred to as a “plasticizing amount”. The phrase “plasticizing amount” includes amounts of plasticizer that are sufficient to plasticize the cellulose acetate present in the foamable composition to facilitate formation of a melt and melt processing into useful articles. One of ordinary skill will appreciate that the specific amount of plasticizer that may constitute a “plasticizing amount” may depend on a number of factors such as for example cellulose acetate selection and selection, amount and additives present in the composition. For example, the presence of certain processing aids such as lubricants, waxes, mold release agents, rheology modifiers and the like in the composition can reduce the amount plasticizer necessary to plasticize the cellulose acetate.

In embodiments, the plasticizer may be present in an amount from 1 to 40 wt % for most thermoplastics processing. The amount of plasticizer may vary based on a number of factors that include the type of thermal processing or melt processing used to make an article from the composition. Non-limiting processing examples include extrusion such as profile extrusion and sheet extrusion; injection molding; compression molding; thermoforming; and the like. Accordingly, articles that may include or be formed from or be prepared using the composition may include extruded articles such as profile extruded articles and sheet extruded articles; injection molded articles; compression molded articles; blow molded articles; thermoformed articles; and the like. In embodiments, the cellulose acetate composition comprises at least one plasticizer (as described herein) in an amount from 1 to 40 wt %, or 5 to 40 wt %, or 5% to 30%, or 10 to 40 wt %, or 13 to 40 wt %, or 15 to 50 wt % or 15 to 40 wt %, or 17 to 40 wt %, or 20 to 40 wt %, or 25 to 40 wt %, or 5 to 35 wt %, or 10 to 35 wt %, or 13 to 35 wt %, or 15 to 35 wt %, or greater than 15 to 35 wt %, or 17 to 35 wt %, or 20 to 35 wt %, or 5 to 30 wt %, or 10 to 30 wt %, or 13 to 30 wt %, or 15 to 30 wt %, or greater than 15 to 30 wt %, or 17 to 30 wt %, or 5 to 25 wt %, or 10 to 25 wt %, or 13 to 25 wt %, or 15 to 25 wt %, or greater than 15 to 25 wt %, or 17 to 25 wt %, or 5 to 20 wt %, or 10 to 20 wt %, or 13 to 20 wt %, or 15 to 20 wt %, or greater than 15 to 20 wt %, or 17 to 20 wt %, or 5 to 17 wt %, or 10 to 17 wt %, or 13 to 17 wt %, or 15 to 17 wt %, or greater than 15 to 17 wt %, or 5 to less than 17 wt %, or 10 to less than 17 wt %, or 13 to less than 17 wt %, or 15 to less than 17 wt %, all based on the total weight of the melt-processable cellulose acetate composition. In embodiments, the at least one plasticizer includes or is a food-compliant plasticizer. In one or more embodiments, the food-compliant plasticizer includes or is triacetin. In one or more embodiments, the plasticizer may be a plasticizer with recycle content.

The foamable composition further includes a nucleating agent. In one or more embodiments, the nucleating agent is selected from the group consisting of a physical nucleating agent and a chemical nucleating agent and combinations thereof. In one or more embodiments, the nucleating agent is a physical nucleating agent. In one or more embodiments, the physical nucleating agent has a median particle size of less than 2 microns or is a particulate composition with a median particle size of less than 2 microns. In one class of this embodiment, the physical nucleating agent comprises a particulate composition with a median particle size of from 0.1 to 2 microns. In one class of this embodiment, the physical nucleating agent comprises a particulate composition with a median particle size of from 0.5 to 2 microns. In one class of this embodiment, the physical nucleating agent comprises a particulate composition with a median particle size of from 1 to 2 microns. In one or more embodiments, the physical nucleating agent is selected from the group consisting of talc, a magnesium silicate, a silicon dioxide, a magnesium oxide, CaCO₃, mica, and mixtures or combinations thereof. In one or more embodiments, the physical nucleating agent comprises talc.

In one or more embodiments, the nucleating agent is present in the foamable composition in an amount of from 0.5 to 6.0 wt % or 0.5 to 5.0 wt. % or 0.5 to 4.0 wt. % or 1.0 to 5.0 wt. % or 1.0 to 4.0 wt. % based on the total weight of the foamable composition. In one or more embodiments, the nucleating agent is a physical nucleating agent present in the foamable composition in an amount of from 1.0 to 6.0 wt % or 1.0 to 5.0 wt. % or 1.0 to 4.0 wt. % or 2.0 to 5.0 wt. % or 2.0 to 4.0 wt. % physical nucleating agent is present at am amount of from 0.1 to 2.5 wt %, or 0.1 to 2.0 wt %, or 0.1 to 1.5 wt %, or 0.1 to 1.0 wt %, or 0.1 to 0.5 wt %, or 0.2 to 3.0 wt %, or 0.2 to 2.5 wt %, or 0.2 to 2.0 wt %, or 0.2 to 1.5 wt %, or 0.2 to 1.0 wt %, or 0.2 to 0.5 wt %, or 0.5 to 2.5 wt %, or 0.5 to 2.0 wt %, or 0.5 to 1.5 wt %, 0.5 to 1.0 wt %, or 1.0 to 6.0 wt %, or 1.0 to 5.5 wt %, or 1.0 to 5.0 wt %, 1.0 to 4.5 wt %, or 1.0 to 4.0 wt %, or 1.0 to 3.5 wt %, or 1.0 to 3.0 wt %, or 1.0 to 2.5 wt %, or 1.0 to 2.0 wt %, or 1.0 to 1.5 wt %, or 1.5 to 6.0 wt %, or 1.5 to 5.5 wt %, or 1.5 to 5.0 wt %, or 1.5 to 4.5 wt %, or 1.5 to 4.0 wt %, or 1.5 to 3.5 wt %, or 1.5 to 3.0 wt %, or 1.5 to 2.5 wt %, or 1.5 to 2.0 wt %, or 2.0 to 6.0 wt %, or 2.0 to 5.5 wt %, or 2.0 to 5.0 wt %, or 2.0 to 4.5 wt %, or 2.0 to 4.0 wt %, or 2.0 to 3.5 wt %, or 2.0 to 3.0 wt %, or 2.0 to 2.5 wt %, or 2.5 to 6.0 wt %, or 2.5 to 5.5 wt %, or 2.5 to 5.0 wt %, or 2.5 to 4.5 wt %, or 2.5 to 4.0 wt %, or 2.5 to 3.5 wt %, or 2.5 to 3.0 wt %, or 3.0 to 6.0 wt %, or 3.0 to 5.5 wt %, or 3.0 to 5.0 wt %, or 3.0 to 4.5 wt %, or 3.0 to 4.0 wt %, or 3.0 to 3.5 wt %, or 3.5 to 6.0 wt %, or 3.5 to 5.5 wt %, or 3.5 to 5.0 wt %, or 3.5 to 4.5 wt %, or 3.5 to 4.0 wt %, or 4.0 to 6.0 wt %, or 4.0 to 5.5 wt %, or 4.0 to 5.0 wt %, or 4.0 to 4.5 wt %, or 4.5 to 6.0 wt %, or 4.5 to 5.5 wt %, or 4.5 to 5.0 wt % based on the total weight of the foamable composition.

The foamable composition of the present invention further includes a blowing agent. In one or more embodiments, the blowing agent is a physical blowing agent. In one or more embodiments, the blowing agent is a physical blowing agent present in the foamable composition in an amount of from 1.5 to 10.0 wt % or 1.5 to 9.5 wt % or 1.5 to 9.0 wt % or 1.5 to 8.5 wt % or 1.5 to 8.0 wt % or 2.0 to 10.0 wt % or 2.5 to 10.0 wt % or 3.0 to 10.0 wt % or 3.5 to 10.0 wt % of physical blowing agent based on the total weight of the foamable composition. In one or more embodiments, the physical blowing agent is selected from the group consisting of ((C₁₋₃)alkyl)₂O, CO₂, N₂, a ((C₁₋₃)alkyl)₂CO, (C₁₋₆)alkanol, (C₄₋₆)alkene, C₃₋₆ hydrocarbons such as propane, n-butane, isobutane, n-pentane, isopentane, C₂₋₅ esters such methyl acetate, ethyl acetate, propyl acetate, methyl formate, ethyl formate, water and combinations thereof. In one or more embodiments, the physical blowing agent is selected from the group consisting of CO₂, acetone, ethanol, isopropanol, ethyl acetate, water, Propane, Isobutane, n-pentane, Isopentane and combinations thereof. In one or more embodiments, the physical blowing agent is chosen from carbon dioxide, a linear or branched (C₁₋₆)alkanol, CH₃COO(C₁₋₃)alkyl, a linear or branched (C₃₋₆)alkane, ((C₁₋₃)alkyl)₂CO, or a combination thereof. In one or more embodiments, the physical blowing agent comprises CO₂ and at least one of acetone, ethanol, isopropanol, or ethyl acetate. In one or more embodiments, the physical blowing agent includes 1.5 to 10.0 wt % or 1.5 to 9.5 wt % or 1.5 to 9.0 wt % or 1.5 to 8.5 wt % or 1.5 to 8.5 wt % or 1.5 to 8.0 wt % or 2.0 to 10.0 wt % or 2.5 to 10.0 wt % based on the total weight of the foamable composition. In one or more embodiments, the physical blowing agent comprises CO₂ in an amount of 2.5 wt. % to 4 wt. % based on the total weight of the foamable composition.

The foamable compositions of the present invention (or the foams or the articles described elsewhere herein) may optionally include other additives such as fillers, stabilizers, odor modifiers, waxes, compatibilizers, biodegradation promoters, dyes, pigments, colorants, lubricants, anti-oxidants, viscosity modifiers, antifungal agents, heat stabilizers, antibacterial agents, softening agents, mold release agents, and combinations thereof. It should be noted that the same type of compounds or materials can be identified for or included in multiple categories of components in the cellulose acetate compositions. For example, polyethylene glycol (PEG) could function as a plasticizer or as an additive that does not function as a plasticizer, such as a hydrophilic polymer or biodegradation promotor, e.g., where a lower molecular weight PEG has a plasticizing effect and a higher molecular weight PEG functions as a hydrophilic polymer but without plasticizing effect.

In one or more embodiments, the foamable compositions of the present invention (or the foams or the articles described elsewhere herein) may include at least one stabilizer. Although it is desirable for the foamable composition and/or the foam to be compostable and/or biodegradable, a certain amount of stabilizer may be added to provide a selected shelf life or stability, e.g., towards light exposure, oxidative stability, or hydrolytic stability. In various embodiments, stabilizers can include: UV absorbers, antioxidants (ascorbic acid, BHT, BHA, etc.), other acid and radical scavengers, epoxidized oils, e.g., epoxidized soybean oil, or combinations thereof. Antioxidants can be classified into several classes, including primary antioxidant, and secondary antioxidant. Primary antioxidants a generally known to function essentially as free radical terminators (scavengers). Secondary antioxidants are generally known to decompose hydroperoxides (ROOH) into nonreactive products before they decompose into alkoxy and hydroxy radicals. Secondary antioxidants are often used in combination with free radical scavengers (primary antioxidants) to achieve a synergistic inhibition effect and secondary AOs are used to extend the life of phenolic type primary AOs.

“Primary antioxidants” are antioxidants that act by reacting with peroxide radicals via a hydrogen transfer to quench the radicals. Primary antioxidants generally contain reactive hydroxy or amino groups such as in hindered phenols and secondary aromatic amines. Examples of primary antioxidants include BHT, Irganox™ 1010, 1076, 1726, 245, 1098, 259, and 1425; Ethanox™ 310, 376, 314, and 330; Evernox™ 10, 76, 1335, 1330, 3114, MD 1024, 1098, 1726, 120. 2246, and 565; Anox™ 20, 29, 330, 70, IC-14, and 1315; Lowinox™ 520, 1790, 22IB46, 22M46, 44B25, AH25, GP45, CA22, CPL,3 HD98, TBM-6, and WSP; Naugard™ 431, PS48, SP, and 445; Songnox™ 1010, 1024, 1035, 1076 CP, 1135 LQ, 1290 PW, 1330FF, 1330 PW, 2590 PW, and 3114 FF; and ADK Stab AO-20, AO-30, AO-40, AO-50, AO-60, AO-80, and AO-330.

“Secondary antioxidants” are often called hydroperoxide decomposers. They act by reacting with hydroperoxides to decompose them into nonreactive and thermally stable products that are not radicals. They are often used in conjunction with primary antioxidants. Examples of secondary antioxidants include the organophosphorous (e.g., phosphites, phosphonites) and organosulfur classes of compounds. The phosphorous and sulfur atoms of these compounds react with peroxides to convert the peroxides into alcohols. Examples of secondary antioxidants include Ultranox 626, Ethanox™ 368, 326, and 327; Doverphos™ LPG11, LPG12, DP S-680, 4, 10, S480, S-9228, S-9228T; Evernox™ 168 and 626; Irgafos™ 126 and 168; Weston™ DPDP, DPP, EHDP, PDDP, TDP, TLP, and TPP; Mark™ CH 302, CH 55, TNPP, CH66, CH 300, CH 301, CH 302, CH 304, and CH 305; ADK Stab 2112, HP-10, PEP-8, PEP-36, 1178, 135A, 1500, 3010, C, and TPP; Weston 439, DHOP, DPDP, DPP, DPTDP, EHDP, PDDP, PNPG, PTP, PTP, TDP, TLP, TPP, 398, 399, 430, 705, 705T, TLTTP, and TNPP; Alkanox 240, 626, 626A, 627AV, 618F, and 619F; and Songnox™ 1680 FF, 1680 PW, and 6280 FF.

In one or more embodiments, the foamable compositions of the present invention (or the foams or the articles described elsewhere herein) may include at least one stabilizer, wherein the stabilizer comprises one or more secondary antioxidants. In embodiments, the stabilizer comprises a first stabilizer component chosen from one or more secondary antioxidants and a second stabilizer component chosen from one or more primary antioxidants, citric acid or a combination thereof.

In embodiments, the stabilizer may comprise one or more secondary antioxidants in an amount in the range of from 0.01 to 0.8, or 0.01 to 0.7, or 0.01 to 0.5, or 0.01 to 0.4, or 0.01 to 0.3, or 0.01 to 0.25, or 0.01 to 0.2, or 0.05 to 0.8, or 0.05 to 0.7, or 0.05 to 0.5, or 0.05 to 0.4, or 0.05 to 0.3, or 0.05 to 0.25, or 0.05 to 0.2, or 0.08 to 0.8, or 0.08 to 0.7, or 0.08 to 0.5, or 0.08 to 0.4, or 0.08 to 0.3, or 0.08 to 0.25, or 0.08 to 0.2, in weight percent of the total amount of secondary antioxidants based on the total weight of the composition. In one class of this embodiment, the stabilizer comprises a secondary antioxidant that is a phosphite compound. In one class of this embodiment, the stabilizer comprises a secondary antioxidant that is a phosphite compound and another secondary antioxidant that is DLTDP.

In one subclass of this class, the stabilizer further comprises a second stabilizer component that comprises one or more primary antioxidants in an amount in the range of from 0.05 to 0.7, or 0.05 to 0.6, or 0.05 to 0.5, or 0.05 to 0.4, or 0.05 to 0.3, or 0.1 to 0.6, or 0.1 to 0.5, or 0.1 to 0.4, or 0.1 to 0.3, in weight percent of the total amount of primary antioxidants based on the total weight of the composition. In one subclass of this class, the stabilizer further comprises a second stabilizer component that comprises citric acid in an amount in the range of from 0.05 to 0.2, or 0.05 to 0.15, or 0.05 to 0.1 in weight percent of the total amount of citric acid based on the total weight of the composition. In one subclass of this class, the stabilizer further comprises a second stabilizer component that comprises one or more primary antioxidants and citric acid in the amounts discussed herein. In one subclass of this class, the stabilizer comprises less than 0.1 wt % or no primary antioxidants, based on the total weight of the composition. In one subclass of this class, the stabilizer comprises less than 0.05 wt % or no primary antioxidants, based on the total weight of the composition.

In one or more embodiments, the foamable compositions of the present invention (or the foams or the articles described elsewhere herein) may include at least one odor modifying additive. Suitable odor modifying additives can be chosen from: vanillin, Pennyroyal M-1178, almond, cinnamyl, spices, spice extracts, volatile organic compounds or small molecules, and Plastidor. In one or more embodiments, the odor modifying additive can be vanillin. In one or more embodiments, the cellulose acetate composition can include an odor modifying additive in an amount from 0.01 to 1 wt %, or 0.1 to 0.5 wt %, or 0.1 to 0.25 wt %, or 0.1 to 0.2 wt %, based on the total weight of the composition. Mechanisms for the odor modifying additives can include masking, capturing, complementing or combinations of these.

In one or more embodiments, the foamable compositions of the present invention (or the foams or the articles described elsewhere herein) may include at least one compatibilizer. In embodiments, the compatibilizer can be either a non-reactive compatibilizer or a reactive compatibilizer. The compatibilizer can enhance the ability of the cellulose acetate or another component to reach a desired small particle size to improve the dispersion of the chosen component in the composition. In such embodiments, depending on the desired formulation, the cellulose acetate can either be in the continuous or discontinuous phase of the dispersion. In embodiments, the compatibilizers used can improve mechanical and/or physical properties of the compositions by modifying the interfacial interaction/bonding between the cellulose acetate and another component, e.g., biodegradable polymer.

In one or more embodiments, the cellulose acetate composition comprises a compatibilizer in an amount from about 1 to about 40 wt %, or about 1 to about 30 wt %, or about 1 to about 20 wt %, or about 1 to about 10 wt %, or about 5 to about 20 wt %, or about 5 to about 10 wt %, or about 10 to about 30 wt %, or about 10 to about 20 wt %, based on the weight of the cellulose acetate composition.

In one or more embodiments, the foamable compositions of the present invention (or the foams or the articles described elsewhere herein) can include biodegradation and/or decomposition agents, e.g., hydrolysis assistants or any intentional degradation promoter additives that can be purposefully added to or contained in the foamable composition, added either during manufacture of the cellulose acetate or subsequent to its manufacture and melt or solvent blended together with the cellulose acetate to make the foamable composition. In embodiments, additives can promote hydrolysis by releasing acidic or basic residues, and/or accelerate photo (UV) or oxidative degradation and/or promote the growth of selective microbial colony to aid the disintegration and biodegradation in compost and soil medium. In addition to promoting the degradation, these additives can have an additional function such as improving the processability of the article or improving desired mechanical properties.

Non-limiting examples of decomposition agents include inorganic carbonate, synthetic carbonate, nepheline syenite, talc, magnesium hydroxide, aluminum hydroxide, diatomaceous earth, natural or synthetic silica, calcined clay, and the like. In one or more embodiments, it may be desirable that these additives are dispersed well in the foamable matrix. The additives can be used singly, or in a combination of two or more.

Other non-limiting examples of decomposition agents are aromatic ketones used as an oxidative decomposition agent, including benzophenone, anthraquinone, anthrone, acetylbenzophenone, 4-octylbenzophenone, and the like. These aromatic ketones may be used singly, or in a combination of two or more.

Other examples include transition metal compounds used as oxidative decomposition agents, such as salts of cobalt or magnesium, e.g., aliphatic carboxylic acid (C12 to C20) salts of cobalt or magnesium, or cobalt stearate, cobalt oleate, magnesium stearate, and magnesium oleate; or anatase-form titanium dioxide, or titanium dioxide may be used. Mixed phase titanium dioxide particles may be used in which both rutile and anatase crystalline structures are present in the same particle. The particles of photoactive agent can have a relatively high surface area, for example from about 10 to about 300 sq. m/g, or from 20 to 200 sq. m/g, as measured by the BET surface area method. The photoactive agent can be added to the plasticizer if desired. These transition metal compounds can be used singly, or in a combination of two or more.

Examples of rare earth compounds that can used as oxidative decomposition agents include rare earths belonging to periodic table Group 3A, and oxides thereof. Specific examples thereof include cerium (Ce), yttrium (Y), neodymium (Nd), rare earth oxides, hydroxides, rare earth sulfates, rare earth nitrates, rare earth acetates, rare earth chlorides, rare earth carboxylates, and the like. More specific examples thereof include cerium oxide, ceric sulfate, ceric ammonium Sulfate, ceric ammonium nitrate, cerium acetate, lanthanum nitrate, cerium chloride, cerium nitrate, cerium hydroxide, cerium octylate, lanthanum oxide, yttrium oxide, Scandium oxide, and the like. These rare earth compounds may be used singly, or in a combination of two or more.

In one or more embodiments, the foamable compositions of the present invention (or the foams or the articles described elsewhere herein) may include an additive with pro-degradant functionality to enhance biodegradability. The additive with pro-degradant functionality may include a transition metal salt or chemical catalyst, containing transition metals such as cobalt, manganese and iron. The transition metal salt can comprise of tartrate, stearate, oleate, citrate and chloride. The additive can further comprise of a free radical scavenging system and one or more inorganic or organic fillers such as chalk, talc, silica, wollastonite, starch, cotton, reclaimed cardboard and plant matter. The additive can also comprise an enzyme, a bacterial culture, a swelling agent, CMC, sugar or other energy sources. The additive can also comprise hydroxylamine esters and thio compounds.

In one or more embodiments, biodegradation and/or decomposition agents can include swelling agents and disintegrants. Swelling agents can be hydrophilic materials that increase in volume after absorbing water and exert pressure on the surrounding foam matrix. Disintegrants can be additives that promote the breakup of a foam matrix into smaller fragments in an aqueous environment. Examples include minerals and polymers, including crosslinked or modified polymers and swellable hydrogels. In embodiments, the foamable compositions of the present invention (or the foams or the articles described elsewhere herein) may include water-swellable minerals or clays and their salts, such as laponite and bentonite; hydrophilic polymers, such as poly(acrylic acid) and salts, poly(acrylamide), poly(ethylene glycol) and poly(vinyl alcohol); polysaccharides and gums, such as starch, alginate, pectin, chitosan, psyllium, xanthan gum; guar gum, locust bean gum; and modified polymers, such as crosslinked PVP, sodium starch glycolate, carboxymethyl cellulose, gelatinized starch, croscarmellose sodium; or combinations of these additives.

In one or more embodiments, the foamable compositions of the present invention (or the foams or the articles described elsewhere herein) may include a pH-basic additive that can increase decomposition or degradation of the composition or article made from (or comprising) the composition. Examples of basic additives that may be used as oxidative decomposition agents include alkaline earth metal oxides, alkaline earth metal hydroxides, alkaline earth metal carbonates, alkali metal carbonates, alkali metal bicarbonates, ZnO and basic Al₂O₃. In embodiments, at least one basic additive can be MgO, Mg(OH)₂, MgCO₃, CaO, Ca(OH)₂, CaCO₃, NaHCO₃, Na₂CO₃, K₂CO₃, ZnO KHCO₃ or basic Al₂O₃. In one aspect, alkaline earth metal oxides, ZnO and basic Al₂O₃ can be used as a basic additive. In embodiments, combinations of different basic additives, or basic additives with other additives, can be used. In embodiments, the basic additive has a pH in the range from greater than 7.0 to 10.0, or 7.1 to 9.5, or 7.1 to 9.0, or 7.1 to 8.5, or 7.1 to 8.0, measured in a 1 wt % mixture/solution of water.

Non-limiting examples of organic acid additives that may be included as oxidative decomposition agents in the foamable compositions of the present invention (or the foams or the articles described elsewhere herein) include acetic acid, propionic acid, butyric acid, valeric acid, citric acid, tartaric acid, oxalic acid, malic acid, benzoic acid, formate, acetate, propionate, butyrate, valerate citrate, tartarate, oxalate, malate, maleic acid, maleate, phthalic acid, phthalate, benzoate, and combinations thereof.

Non-limiting examples of other hydrophilic polymers or biodegradation promoters that may be included in the foamable compositions of the present invention (or the foams or the articles described elsewhere herein) include glycols, polyglycols, polyethers, and polyalcohols or other biodegradable polymers such as poly(glycolic acid), poly(lactic acid), polyethylene glycol, polypropylene glycol, polydioxanes, polyoxalates, poly(α-esters), polycarbonates, polyanhydrides, polyacetals, polycaprolactones, poly(orthoesters), polyamino acids, aliphatic polyesters such as poly(butylene) succinate, poly(ethylene) succinate, starch (modified or native), regenerated cellulose, or aliphatic-aromatic polyesters such as PBAT.

Non-limiting examples of colorants that may be included in the foamable compositions of the present invention (or the foams or the articles described elsewhere herein) include carbon black, iron oxides such as red or blue iron oxides, titanium dioxide, silicon dioxide, cadmium red, calcium carbonate, kaolin clay, aluminum hydroxide, barium sulfate, zinc oxide, aluminum oxide; and organic pigments such as azo and diazo and triazo pigments, condensed azo, azo lakes, naphthol pigments, anthrapyrimidine, benzimidazolone, carbazole, diketopyrrolopyrrole, flavanthrone, indigoid pigments, isoindolinone, isoindoline, isoviolanthrone, metal complex pigments, oxazine, perylene, perinone, pyranthrone, pyrazoloquinazolone, quinophthalone, triarylcarbonium pigments, triphendioxazine, xanthene, thioindigo, indanthrone, isoindanthrone, anthanthrone, anthraquinone, isodibenzanthrone, triphendioxazine, quinacridone and phthalocyanine series, especially copper phthalocyanme and its nuclear halogenated derivatives, and also lakes of acid, basic and mordant dyes, and isoindolinone pigments, as well as plant and vegetable dyes, and any other available colorant or dye.

Non-limiting examples of luster control agents (for adjusting glossiness) and fillers thta may be included in the foamable compositions of the present invention (or the foams or the articles described elsewhere herein) can include silica, talc, clay, barium sulfate, barium carbonate, calcium sulfate, calcium carbonate, magnesium carbonate, and the like.

Non-limiting examples of flame retardants that may be included in the foamable compositions of the present invention (or the foams or the articles described elsewhere herein) can include silica, metal oxides, phosphates, catechol phosphates, resorcinol phosphates, borates, inorganic hydrates, and aromatic polyhalides.

Although it is desirable for the cellulose acetate composition and/or the foam to be one or more of disintegrable, composable and/or biodegradable, a certain amount of anti-fungal, antimicrobial or antibacterial agents may be added to provide a selected shelf life, useful service life or stability. Non-limiting examples of such agents that may be included in the foamable compositions of the present invention (or the foams or the articles described elsewhere herein) include polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Non-limiting examples of viscosity modifiers (for modifying the melt flow index or viscosity of the foamable composition) that can be included in the foamable compositions of the present invention (or the foams or the articles described elsewhere herein) include polyethylene glycols and polypropylene glycols, and glycerin.

Other non-limiting examples of additives that may be included in the foamable compositions of the present invention (or the foams or the articles described elsewhere herein) include release agents or lubricants such as fatty acids, fatty acid esters, fatty acid amides, glycerol esters (ethylene glycol distearate or glycerol monostearate); anti-block or slip agents such as fatty acid esters, metal stearate salts (for example, zinc stearate), and waxes; antifogging agents such as surfactants); thermal stabilizers such as epoxy stabilizers, derivatives of epoxidized soybean oil (ESBO), linseed oil, and sunflower oil); anti-static agents; foaming agents; biocides; impact modifiers and reinforcing fibers. Additives may be included in various combinations to for example impart desirable processing characteristics and/or performance or aesthetic characteristics in specific end-use applications. It should be noted that an additive or component may serve more than one function or purpose in the foamable compositions of the present invention (or the foams or the articles described elsewhere herein) composition. The different (or specific) functionality of any particular additive or component can be dependent on its physical properties (e.g., molecular weight, solubility, melt temperature, Tg, etc.) and/or the amount of such additive/component in the foamable compositions of the present invention (or the foams or the articles described elsewhere herein). For example, polyethylene glycol can function as a plasticizer at one molecular weight or as a hydrophilic agent (with little or no plasticizing effect) at another molecular weight.

In one or more embodiments, the foamable compositions of the present invention (or the foams or the articles described elsewhere herein) may include one or more fragrances. Non-limiting examples of fragrances include spices, spice extracts, herb extracts, essential oils, smelling salts, volatile organic compounds, volatile small molecules, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, isoeugenol, cinnamaldehyde, ethyl maltol, vanilla, vanillin, cinnamyl alcohol, anisole, anethole, estragole, thymol, furaneol, methanol, rosemary, lavender, citrus, freesia, apricot blossoms, greens, peach, jasmine, rosewood, pine, thyme, oakmoss, musk, vetiver, myrrh, blackcurrant, bergamot, grapefruit, acacia, passiflora, sandalwood, tonka bean, mandarin, neroli, violet leaves, gardenia, red fruits, ylang-ylang, acacia farnesiana, mimosa, tonka bean, woods, ambergris, daffodil, hyacinth, narcissus, black currant bud, iris, raspberry, lily of the valley, sandalwood, vetiver, cedarwood, neroli, strawberry, carnation, oregano, honey, civet, heliotrope, caramel, coumarin, patchouli, dewberry, helonial, coriander, pimento berry, labdanum, cassie, aldehydes, orchid, amber, orris, tuberose, palmarosa, cinnamon, nutmeg, moss, styrax, pineapple, foxglove, tulip, wisteria, clematis, ambergris, gums, resins, civet, plum, castoreum, civet, myrrh, geranium, rose violet, jonquil, spicy carnation, galbanum, petitgrain, iris, honeysuckle, pepper, raspberry, benzoin, mango, coconut, hesperides, castoreum, osmanthus, mousse de chene, nectarine, mint, anise, cinnamon, orris, apricot, plumeria, marigold, rose otto, narcissus, tolu balsam, frankincense, amber, orange blossom, bourbon vetiver, opopanax, white musk, papaya, sugar candy, jackfruit, honeydew, lotus blossom, muguet, mulberry, absinthe, ginger, juniper berries, spicebush, peony, violet, lemon, lime, hibiscus, white rum, basil, lavender, balsamics, fo-ti-tieng, osmanthus, karo karunde, white orchid, calla lilies, white rose, rhubrum lily, tagetes, ambergris, ivy, grass, seringa, spearmint, clary sage, cottonwood, grapes, brimbelle, lotus, cyclamen, orchid, glycine, tiare flower, ginger lily, green osmanthus, passion flower, blue rose, bay rum, cassie, African tagetes, Anatolian rose, Auvergne narcissus, British broom, British broom chocolate, Bulgarian rose, Chinese patchouli, Chinese gardenia, Calabrian mandarin, Comoros Island tuberose, Ceylonese cardamom, Caribbean passion fruit, Damascena rose, Georgia peach, white Madonna lily, Egyptian jasmine, Egyptian marigold, Ethiopian civet, Farnesian cassie, Florentine iris, French jasmine, French jonquil, French hyacinth, Guinea oranges, Guyana wacapua, Grasse petitgrain, Grasse rose, Grasse tuberose, Haitian vetiver, Hawaiian pineapple, Israeli basil, Indian sandalwood, Indian Ocean vanilla, Italian bergamot, Italian iris, Jamaican pepper, May rose, Madagascar ylang-ylang, Madagascar vanilla, Moroccan jasmine, Moroccan rose, Moroccan oakmoss, Moroccan orange blossom, Mysore sandalwood, Oriental rose, Russian leather, Russian coriander, Sicilian mandarin, South African marigold, South American tonka bean, Singapore patchouli, Spanish orange blossom, Sicilian lime, Reunion Island vetiver, Turkish rose, Thai benzoin, Tunisian orange blossom, Yugoslavian oakmoss, Virginian cedarwood, Utah yarrow, West Indian rosewood, and the like, and any combination thereof.

In one embodiment or in combination with any other embodiment mentioned herein, the foamable compositions of the present invention (or the foams or the articles described elsewhere herein) may include a photodegradation catalyst. Non-limiting examples of a photodegradation catalyst include titanium dioxides and iron oxides. In one subclass of this class, the photodegradation catalyst is a titanium dioxide. In one subclass of this class, the photodegradation catalyst is an iron oxide.

In one embodiment or in combination with any other embodiment mentioned herein, the foam, composition, or foamable composition further comprises a pigment. In one class of this embodiment, the pigment is a titanium dioxide, a carbon black, or an iron oxide. In one subclass of this class, the pigment is a titanium dioxide. In one subclass of this class, the pigment is a carbon black. In one subclass of this class, the pigment is an iron oxide.

In one or more embodiments, the foamable compositions of the present invention (or the foams or the articles described elsewhere herein) may include at least one filler. The filler may be of a type and present in an amount to enhance biodegradability and/or compostability. In one or more embodiments, the foamable compositions of the present invention (or the foams or the articles described elsewhere herein) may include at least one filler selected from the group consisting of: carbohydrates (sugars and salts), cellulosic and organic fillers (wood flour, wood fibers, hemp, carbon, coal particles, graphite, and starches), mineral and inorganic fillers (calcium carbonate, talc, silica, titanium dioxide, glass fibers, glass spheres, boronitride, aluminum trihydrate, magnesium hydroxide, calcium hydroxide, alumina, and clays), food wastes or byproduct (eggshells, distillers grain, and coffee grounds), desiccants (e.g. calcium sulfate, magnesium sulfate, magnesium oxide, calcium oxide), alkaline fillers (e.g., Na₂CO₃, MgCO₃), or combinations (e.g., mixtures) of these fillers. In embodiments, the cellulose acetate compositions can include at least one filler that also functions as a colorant additive. In embodiments, the colorant additive filler can be chosen from: carbon, graphite, titanium dioxide, opacifiers, dyes, pigments, toners and combinations thereof. In embodiments, the foamable compositions of the present invention (or the foams or the articles described elsewhere herein) can include at least one filler that also functions as a stabilizer or flame retardant.

In embodiments, the foamable compositions of the present invention (or the foams or the articles described elsewhere herein) further comprises at least one filler in an amount from 1 to 60 wt %, or 5 to 55 wt %, or 5 to 50 wt %, or 5 to 45 wt %, or 5 to 40 wt %, or 5 to 35 wt %, or 5 to 30 wt %, or 5 to 25 wt %, or 10 to 55 wt %, or 10 to 50 wt %, or 10 to 45 wt %, or 10 to 40 wt %, or 10 to 35 wt %, or 10 to 30 wt %, or 10 to 25 wt %, or 15 to 55 wt %, or 15 to 50 wt %, or 15 to 45 wt %, or 15 to 40 wt %, or 15 to 35 wt %, or 15 to 30 wt %, or 15 to 25 wt %, or 20 to 55 wt %, or 20 to 50 wt %, or 20 to 45 wt %, or 20 to 40 wt %, or 20 to 35 wt %, or 20 to 30 wt %, all based on the total weight of the foamable compositions of the present invention (or the foams or the articles described elsewhere herein).

In one embodiment or in combination with any of the embodiments mentioned herein, the foamable compositions of the present invention (or the foams or the articles described elsewhere herein) further comprises a biodegradable filler. In one class of this embodiment, the biodegradable filler is a natural filler. In one class of this embodiment, the biodegradable filler comprises hemp, agave, bagasse, bast, jute, flax, ramie, kenaf, sisal, bamboo, or wood cellulose fibers. In one subclass of this class, the biodegradable filler comprises bast fibers. In one subclass of this class, the biodegradable filler comprises agave fibers. In one subclass of this class, the biodegradable filler comprises bagasse fibers. In one subclass of this class, the biodegradable filler comprises jute fibers. In one subclass of this class, the biodegradable filler comprises flax fibers. In one subclass of this class, the biodegradable filler comprises hemp fibers. In one subclass of this class, the biodegradable filler comprises ramie fibers. In one subclass of this class, the biodegradable filler comprises kenaf fibers. In one subclass of this class, the biodegradable filler comprises bamboo fibers. In one subclass of this class, the biodegradable filler comprises wood cellulose fibers.

In one embodiment or in combination with any of the embodiments mentioned herein, the foamable compositions of the present invention (or the foams or the articles described elsewhere herein) may include two or more cellulose acetates having different degrees of substitution of acetyl.

In one embodiment or in combination with any of the embodiments mentioned herein, the foamable compositions of the present invention (or the foams or the articles described elsewhere herein) may further include a biodegradable polymer that is different than the cellulose acetate. In one or more embodiments, the biodegradable polymer can be selected from the group consisting of polyhydroxyalkanoates (PHAs and PHBs), polylactic acid (PLA), polycaprolactone polymers (PCL), polybutylene adipate terephthalate (PBAT), polyethylene succinate (PES), polyvinyl acetates (PVAs), polybutylene succinate (PBS) and copolymers (such as polybutylene succinate-co-adipate (PBSA)), cellulose esters, cellulose ethers, starch, proteins, derivatives thereof, and combinations thereof. In one or more embodiments, the biodegradable polymer is chosen from a polyhydroxylalkanoate (“PHA”), a polylactic acid (“PLA”), a polycaprolactone (“PCL”), a polybutylene succinate (“PBS”), a polybutylene adipate terephthalate (“PBAT”), a cellulose mixed ester, a cellulose ether, a starch, a protein, or combinations thereof. The biodegradable polymer (other than cellulose acetate) is present in an amount from 0.1 to less than 50 wt %, or 1 to 40 wt %, or 1 to 30 wt %, or 1 to 25 wt %, or 1 to 20 wt %, based on the total weight of the foam, composition or foamable composition.

The present invention may be characterized using heat deflection temperature. The heat deflection temperature is a measure of a material's resistance to distortion under a constant load at elevated temperature. For example, ASTM D648 and ISO 75 both measure HDT (heat deflection temperature) on test samples after equilibration of the test materials. Briefly, a test bar is molded of a specific thickness and width. The test sample is equilibrated at 50% relative humidity (RH) and then submerged in oil for which the temperature is raised at a uniform rate (usually 2° C. per minute). The load is applied to the midpoint of the test bar that is supported near both ends. The temperature at which a bar of material is deformed 0.25 mm is recorded as the HDT. As described herein, HDT is typically measured on the foamable composition without a blowing agent additive, which may be described as a melt-processable composition or a foamable composition precursor.

In one embodiment or in combination with any other embodiment, the foamable composition precursor exhibits a heat deflection temperature (HDT) of greater than 80° C. as measured at 0.45 MPa at 2% elongation with a 1 Hz frequency using a DMA. In one embodiment or in combination with any other embodiment, the foamable composition precursor exhibits a heat deflection temperature of greater than 70° C. or 80° C. or 90° C. as measured at 0.45 MPa at 2% elongation with a 1 Hz frequency using a DMA. In one embodiment or in combination with any other embodiment, the foamable composition precursor exhibits a heat deflection temperature of greater than 100° C. as measured at 0.45 MPa at 2% elongation with a 1 Hz frequency using a DMA. In one embodiment or in combination with any other embodiment, the foamable composition precursor exhibits a heat deflection temperature of greater than 102° C. as measured at 0.45 MPa at 2% elongation with a 1 Hz frequency using a DMA. In one embodiment or in combination with any other embodiment, the foamable composition precursor exhibits a heat deflection temperature of greater than 105° C. as measured at 0.45 MPa at 2% elongation with a 1 Hz frequency using a DMA. In one embodiment or in combination with any other embodiment, the foamable composition precursor exhibits a heat deflection temperature of greater than 150° C. as measured at 0.45 MPa at 2% elongation with a 1 Hz frequency using a DMA.

The cellulose acetate foam of the present invention or the foamable composition of the present invention may be characterized using glass transition temperature. In one or more embodiments, the cellulose acetate foam of the present invention may be characterized using glass transition temperature of from 110° C. to 180° C. or from 125° C. to 175° C. or from 130° C. to 170° C. For purposes herein, glass transition temperature is measured using Differential Scanning calorimetry (DSC). DSC was completed using a TA Instruments Q2000 device which determines thermal transitions of the polymer. To analyze the samples, (4 to 8 mg) of each sample was sealed in aluminum DSC pans and evaluated using a heat-cool-heat method. For the 1st heat, the samples were evaluated from 23° C. to 250° C. at a scan rate of 20° C. per minute and transitions were marked. Next the sample was cooled from 250° C. to 23° C. at a scan rate of 20° C. per minute and transitions were marked. Finally, the samples were reheated a second time (second heat method) from 23° C. to 250° C. at a scan rate of 20° C. per minute and the transitions were marked. The Tg was determined during the 2^{nd} heat to minimize the impact of moisture on the sample results. Transitions are marked and recorded in accordance with ASTM D3418.

In another aspect, the present invention is directed to an article. In one or more embodiments, the article of the present invention includes, is prepared from or formed from the cellulose acetate foam of the present invention. The article of the present invention may be prepared from or formed from the foamable composition of the present invention or may include a cellulose acetate foam formed or prepared from the foamable composition of the present invention. Accordingly, in one or more embodiments, the article of the present invention includes, is prepared or is formed from a cellulose acetate foam, wherein the foam has a density of less than 0.20 g/cm³ and an average foam cell size of less than 200 micrometers. In one or more embodiments, the article of the present invention includes a foam that is prepared or formed from a foamable composition that incudes (1) a cellulose acetate having a degree of substitution of acetyl(DS_{Ac}) in the range of from 1.8 to 2.6; 2) 2 to 30 wt % of processing aid; (3) 0.5 to 6.0 wt % of nucleating agent selected from the group consisting a physical nucleating agent and a chemical nucleating agent and combinations thereof; and (4) 1.5 to 10.0 wt % of physical blowing agent, wherein the proportions of each component of the composition is based on the total weight of the foamable composition.

The cellulose acetate foam of the present invention is preferably a foam that is one or more of biodegradable, compostable and disintegrable. As used herein, the term “biodegradable” generally refers to the biological conversion and consumption of organic molecules. Biodegradability is an intrinsic property of the material itself, and the material can exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

Biodegradability may be measured or quantified by one or more industry or governmental standards and the present invention is “biodegradable” if it meets one or more definitions or standards as set forth herein. For example, to be considered “biodegradable” under home composting conditions according to the French norm NF T 51-800 and the Australian standard AS 5810, a material must exhibit a biodegradation of at least 90 percent in total (e.g., as compared to an initial sample of the material), or a biodegradation of at least 90 percent of the maximum degradation of a suitable reference material after a plateau has been reached for both the reference and test item. The maximum test duration for biodegradation under home compositing conditions is 1 year.

In other examples, to be considered “biodegradable” under industrial composting conditions according to ASTM D6400 and ISO 17088, at least 90 percent of the organic carbon in the whole item (or for each constituent present in an amount of more than 1% by dry mass) must be converted to carbon dioxide by the end of the test period when compared to a control or in absolute. According to European standard ED 13432 (2000), a material must exhibit a biodegradation of at least 90 percent in total, or a biodegradation of at least 90 percent of the maximum degradation of a suitable reference material after a plateau has been reached for both the reference and test item. The maximum test duration for biodegradability under industrial compositing conditions is 180 days. In order to be considered “biodegradable,” under soil composting conditions according the OK biodegradable SOIL conformity mark of Vinçotte and the DIN Geprüft Biodegradable in soil certification scheme of DIN CERTCO, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradability under soil compositing conditions is 2 years.

In one embodiment or in combination with any of the embodiments mentioned herein, the cellulose acetate foam or article is industrial compostable or home compostable. To be considered “compostable,” a material must meet the following four criteria: (1) the material should pass biodegradation requirement in a test under controlled composting conditions at elevated temperature (58° C.) according to ISO 14855-1 (2012) which correspond to an absolute 90% biodegradation or a relative 90% to a control polymer, (2) the material tested under aerobic composting condition according to ISO16929 (2013) must reach a 90% disintegration; (3) the test material must fulfill all the requirements on volatile solids, heavy metals and fluorine as stipulated by ASTM D6400 (2012), EN 13432 (2000) and ISO 17088 (2012); and (4) the material should not have negative impact on plant growth.

In one subclass of this class, the foam or article is industrial compostable. In one sub-subclass of this subclass, the foam or article has a thickness that is less than 6 mm. In one sub-subclass of this subclass, the foam or article has a thickness that is less than 3 mm. In one sub-subclass of this subclass, the article has a thickness that is less than 1.1 mm. In one subclass of this class, the foam or article is home compostable. In one sub-subclass of this subclass, the foam or article has a thickness that is less than 6 mm. In one sub-subclass of this subclass, the foam or article has a thickness that is less than 3 mm. In one sub-subclass of this subclass, the foam or article has a thickness that is less than 1.1 mm. In one sub-subclass of this subclass, the foam or article has a thickness that is less than 0.8 mm. In one sub-subclass of this subclass, the foam or article has a thickness that is less than 0.6 mm. In one sub-subclass of this subclass, the foam or article has a thickness that is less than 0.4 mm.

In one embodiment or in combination with any of the embodiments mentioned herein, the thickness of the foam or article is less than 3 mm.

In one embodiment or in combination with any of the embodiments mentioned herein, the foam or article exhibits greater than 90% disintegration after 12 weeks according to the disintegration test protocol for films, as described in the specification.

In one embodiment or in combination with any other embodiment, the foam or article exhibits greater than 30% disintegration after 12 weeks according to Disintegration Test Protocol, as described in the specification or in the alternative according to ISO 16929 (2013). In one embodiment or in combination with any other embodiment, the foam or article exhibits greater than 50% disintegration after 12 weeks according to Disintegration Test Protocol, as described in the specification or in the alternative according to ISO 16929 (2013). In one embodiment or in combination with any other embodiment, the foam or article exhibits greater than 70% disintegration after 12 weeks according to Disintegration Test Protocol, as described in the specification or in the alternative according to ISO 16929 (2013). In one embodiment or in combination with any other embodiment, the foam or article exhibits greater than 80% disintegration after 12 weeks according to Disintegration Test Protocol, as described in the specification or in the alternative according to ISO 16929 (2013). In one embodiment or in combination with any other embodiment, the foam or article exhibits greater than 90% disintegration after 12 weeks according to Disintegration Test Protocol, as described in the specification or in the alternative according to ISO 16929 (2013). In one embodiment or in combination with any other embodiment, the foam or article exhibits greater than 95% disintegration after 12 weeks according to Disintegration Test Protocol, as described in the specification or in the alternative according to ISO 16929 (2013).

In another aspect, the present invention is directed to a method for forming a foam. In this aspect, the method of the present invention incudes (a) forming a melt from a melt-processable composition, said melt-processable composition including (1) a cellulose acetate; (2) plasticizer; and (3) a nucleating agent; (b) adding at least one physical blowing agent to said melt to form a foamable melt; and (c) thermally expanding said foamable melt under conditions sufficient to form a foam therefrom, wherein said conditions include a melt temperature of from 120° C. to 210° C. and an thermal expansion temperature of from 20 to 250 bar. The term “melt” is utilized to generally describe a flowable, liquid form of the composition, sometimes viscous in nature, typically created by raising the composition to a temperature sufficient to facilitate molten flow (in contrast for example to addition of a solvent to form a dispersion, suspension or solution). A melt is typically the form necessary for melt-processing to produce a melt-formed article such as a foam. In describing a composition herein as “melt-processable”, is intended to include compositions which are capable of forming a melt that is processable into useful melt-formed articles using melt processes such as extrusion, including without limitation profile extrusion and sheet extrusion; injection molding; compression molding; blow molding; thermoforming; and the like. “Melt temperature” as used herein is intended to mean the temperature of the melt just prior to the thermal expansion step (c) and “thermal expansion pressure” is used herein to mean the pressure under which the thermal expansion step (c) is performed or the pressure at which the foamable melt is thermally expanded. In one or more embodiments, the thermal expansion step (c) is performed at a melt temperature of from 140° C. to 190° C. and an extrusion pressure of from 50 to 170 bar. In one or more embodiments, the method of the present invention incudes (a) forming a melt of a melt-processable composition, said melt-processable composition including (1) a cellulose acetate having a degree of substitution of acetyl(DS_{Ac}) in the range of from 1.8 to 2.6; 2) 2 to 30 wt % of processing aid; and (3) 0.5 to 6.0 wt % of nucleating agent selected from the group consisting a physical nucleating agent and a chemical nucleating agent and combinations thereof; (b) adding at least one physical blowing agent to said melt to form a foamable melt, said blowing agent added preferably in an amount from 1.5 to 10.0 wt % based on the total weight of the foamable composition; and (c) thermally expanding said foamable melt under conditions sufficient to form a foam therefrom, wherein said conditions include a melt temperature of from 120° C. to 210° C. or from of from 140° C. to 210° C. and an thermal expansion temperature of from 20 to 250 bar.

In one or more embodiments of the method of the present invention, an extruder may be utilized in performing the method; thermally expanding step (c) may be an extruding step and the foam may be an extruded foam. Accordingly, in one or more embodiments, the forming step (a) of the method of method of the present invention may include feeding the cellulose acetate; the plasticizer; and the physical nucleating agent to an extruder under conditions to melt the cellulose acetate. In one or more embodiments, the feeding step may include adding the cellulose acetate and plasticizer as a first feed and adding the physical nucleating agent separately as a second feed. In one or more embodiments, the adding step (b) of the method of the present invention may include injecting the physical blowing agent into an extruder.

The examples and any preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

### Example 1

To demonstrate various aspects and embodiments of the present invention, various foamable compositions and foams were formed as set forth in detail below.

### Materials and Abbreviations

Cellulose acetate CA: procured from Eastman Chemical Company (commercially available from Eastman as product CA-394-60S) with the following characteristics: (DS_{ac}=2.5; melt point=230-250° C.; T_{g} 188-192° C.). Samples were either filtered to remove fiber/gel from manufacture or unfiltered. Samples were stabilized with Vikoflex 7170 (Arkema) or unstabilized as indicated.
Plasticizers (PZ): Triacetin (TA, Eastman, food grade) or PEG (PEG400 (Dow Sentry Polyethylene Glycol 400); plasticizer amounts in weight percent are indicated in Table 2 formulations column next to PZ abbreviation.
Stabilizer: Vikoflex 7170 (Arkema)
Physical Nucleating Agent (PNA): Talc (ABT-1000)
Physical Blowing Agents (PBA): CO2, ethanol, acetone, isopropanol (Mcmaster-Carr) and ethyl acetate (Eastman) as indicated
Other additives: fatty acid (2% lauric/1% myristic eutectic blend)

The formulations were plasticized with Triacetin (TA) at 20 wt % (TA-20), 15 wt % (TA-15), 12.5 wt % (TA-12.5), and at 10 wt % (TA-10), PEG400 at 15 wt % (PEG-15), and 10 wt % (PEG-10), and TEC at 15 wt % (TEC-15). Fatty acids (FA) were also used as an additive with total 3 wt % fatty acid (2% being lauric acid with 1% myristic acid) with Triacetin (TA) at 10 wt % (TA-10/FA-3), unfiltered CA-394-60S with Triacetin (TA) at 15 wt % (TA-15-U), and with non-stabilized (NS, CA-394-60S with Triacetin at 15 wt % (TA-15-NS)). BA means blowing agent.

Foam Formation: (all percentages are weight percent based on total composition weight)

CA, plasticizer, stabilizer and (for certain samples) fatty acid are combined in varying amounts as indicated below by mixing in a co-rotating 40 mm twin screw extruder and forming pellets. The resulting material was fed into a Leistritz 27-mm diameter twin screw extruder equipped with 10 heating zones and either a 4-mm circular rod die, or a 1 mm sheet die, or a 1 mm annular die at the exit as indicated in the Table 1 below. Extruder conditions are set forth in Table 1 below. Temperatures in Zones 1˜4 are set to provide a melt that includes molten polymer with complete mixing of all other components, while temperatures in Zones 6-10 are set at temperatures to bring the molten mixture to the desired extrusion temperature.

Physical Nucleating Agent (Talc) in varying amounts as indicated in Table 2 was separately fed into the twin screw extruder. Physical blowing agents as identified in Table 2 below with amounts as indicated were injected into the extruder barrel at specific rates as indicated. Extrusion of the resulting foamable compositions generated foam rod samples of diameter between 10-25 mm or sheet samples with thickness between 1-5 mm.

Foam samples were then analyzed for density and average cell size, with density measured using an analytical balance where the sample was immersed in water and Archimedes principle was used to measure the volume displacement. Average cell sizes were measured using a Proscope USB Microscope M2, with M100 and M200 lens unit and using Proscope HR/HR2 software. The density and cell size results are set forth in Table 2.

Surface roughness of the extruded foam sheets was analyzed using a Bruker ContourGT optical profilometer. Surface roughness data was measured at 3 spots on a side of the sheet. A 0.55× magnification objective was used and the base roughness (RMS) value was obtained.

TABLE 1
Extruder Conditions

| Sample | Die pressure | Die Temp | Melt Temp | Throughput | Extruder |
|---|---|---|---|---|---|
| # | psi | ° C. | ° C. | rate lb/hr | rpm |
| 1 | 1126 | 181 | 185 | 20 | 55 |
| 2 | 1370 | 181 | 186 | 20 | 55 |
| 3 | 1302 | 175 | 182 | 20 | 55 |
| 4 | 2000 | 175 | 181 | 20 | 55 |
| 5 | 1200 | 175 | 180 | 20 | 55 |
| 6 | 1700 | 175 | 180 | 20 | 55 |
| 7 | 1300 | 175 | 180 | 20 | 55 |
| 8 | 2200 | 175 | 180 | 20 | 55 |
| 9 | 1900 | 175 | 180 | 20 | 55 |
| 10 | 1500 | 170 | 177 | 15 | 55 |
| 11 | 1440 | 175 | 180 | 15 | 55 |
| 12 | 1450 | 175 | 183 | 15 | 50 |
| 13 | 1557 | 177 | 184 | 15 | 45 |
| 14 | 1814 | 177 | 183 | 15 | 45 |
| 15 | 1920 | 177 | 184 | 15 | 45 |
| 16 | 1280 | 174 | 179 | 15 | 50 |
| 17 | 1700 | 174 | 184 | 15 | 45 |
| 18 | 1250 | 177 | 183 | 15 | 45 |
| 19 | 1440 | 177 | 183 | 15 | 45 |
| 20 | 1370 | 177 | 183 | 15 | 45 |
| 21 | 980 | 177 | 184 | 20 | 70 |
| 22 | 850 | 177 | 183 | 20 | 65 |
| 23 | 1280 | 168 | 174 | 20 | 60 |
| 24 | 1064 | 168 | 174 | 20 | 60 |
| 25 | 976 | 170 | 176 | 20 | 60 |
| 26 | 1338 | 181 | 188 | 20 | 60 |
| 27 | 1200 | 181 | 186 | 20 | 60 |
| 28 | 1522 | 176 | 182 | 20 | 60 |
| 29 | 1068 | 173 | 178 | 20 | 60 |
| 30 | 1280 | 178 | 184 | 20 | 65 |
| 31 | 1920 | 178 | 185 | 20 | 65 |
| 32 | 1700 | 178 | 185 | 20 | 65 |
| 33 | 1060 | 172 | 177 | 20 | 59 |
| 34 | 1385 | 171 | 176 | 20 | 55 |
| 35 | 1734 | 171 | 176 | 20 | 55 |
| 36 | 1420 | 171 | 176 | 20 | 55 |
| 37 | 1450 | 171 | 174 | 20 | 58 |
| 38 | 1520 | 171 | 176 | 20 | 58 |
| 39 | 2300 | 171 | 178 | 20 | 58 |
| 40 | 1480 | 171 | 178 | 20 | 58 |
| 41 | 2200 | 171 | 178 | 20 | 58 |
| 42 | 2400 | 171 | 177 | 20 | 58 |
| 43 | 1850 | 176 | 179 | 20 | 55 |
| 44 | 1720 | 175 | 180 | 20 | 55 |
| 45 | 1620 | 175 | 180 | 20 | 55 |
| 46 | 2060 | 180 | 185 | 20 | 60 |
| 47 | 1970 | 175 | 165 | 20 | 70 |
| 48 | 1220 | 178 | 172 | 20 | 60 |
| 49 | 1770 | 168 | 171 | 20 | 60 |
| 50 | 2430 | 168 | 164 | 20 | 60 |
| 51 | 2065 | 159 | 168 | 20 | 60 |
| 52 | 2225 | 159 | 166 | 20 | 60 |
| 53 | 2300 | 173 | 180 | 20 | 75 |
| 54 | 1230 | 175 | 183 | 20 | 80 |
| 55 | 1360 | 174 | 181 | 20 | 70 |
| 56 | 1320 | 174 | 181 | 20 | 70 |
| 57 | 1320 | 174 | 181 | 20 | 70 |
| 58 | 1248 | 172 | 181 | 20 | 72 |
| 59 | 1760 | 170 | 178 | 20 | 60 |
| 60 | 2020 | 168 | 177 | 20 | 60 |
| 61 | 1440 | 168 | 174 | 20 | 60 |
| 62 | 1780 | 190 | 166 | 20 | 60 |
| 63 | 1670 | 190 | 167 | 35 | 90 |

TABLE 2
Foamable Compositions and Foams

| Sample | Talc | BA 1 | BA 2 | | Density | Cell size | Rᵣₘₛ | Article |
|---|---|---|---|---|---|---|---|---|
| # | (wt %) | (wt %) | (Wt %) | Formulation | (g/L) | (μm) | (μm) | type |
| 1 | 1.00 | CO₂ | N/A | TA-20 | 170 | 250 | 20 | Rod |
| | | (2.65) | | | | | | |
| 2 | 1.00 | CO₂ | N/A | TA-20 | 85 | 400 | 27 | Rod |
| | | (3.30) | | | | | | |
| 3 | 1.00 | CO₂ | N/A | TA-20 | 84 | 400 | — | Rod |
| | | (3.30) | | | | | | |
| 4 | 0.00 | CO₂ | N/A | TA-20 | 87 | 1000 | — | Rod |
| | | (3.30) | | | | | | |
| 5 | 1.50 | CO₂ | N/A | TA-20 | 74 | 250 | 14 | Rod |
| | | (3.30) | | | | | | |
| 6 | 2.00 | CO₂ | N/A | TA-20 | 86 | 150 | 14 | Rod |
| | | (3.30) | | | | | | |
| 7 | 2.50 | CO₂ | N/A | TA-20 | 80 | 150 | — | Rod |
| | | (3.30) | | | | | | |
| 8 | 3.00 | CO₂ | N/A | TA-20 | 95 | 125 | 28 | Rod |
| | | (3.30) | | | | | | |
| 9 | 3.00 | CO₂ | N/A | TA-20 | 86 | 175 | — | Rod |
| | | (2.66) | | | | | | |
| 10 | 3.00 | CO₂ | N/A | TA-15 | 58 | 80 | — | Rod |
| | | (2.66) | | | | | | |
| 11 | 3.00 | CO₂ | N/A | TA-15 | 56 | 80 | — | Rod |
| | | (2.66) | | | | | | |
| 12 | 3.00 | CO₂ | N/A | TA-15 | 56 | 80 | — | Rod |
| | | (2.66) | | | | | | |
| 13 | 3.00 | CO₂ | N/A | TA-15 | 59 | 80 | 16 | Rod |
| | | (2.66) | | | | | | |
| 14 | 2.00 | CO₂ | N/A | TA-15 | 59 | 110 | — | Rod |
| | | (2.66) | | | | | | |
| 15 | 1.00 | CO₂ | N/A | TA-15 | 60 | 175 | — | Rod |
| | | (2.66) | | | | | | |
| 16 | 3.00 | Ethanol | N/A | TA-15 | 90 | 1000 | 28 | Rod |
| | | (4.00) | | | | | | |
| 17 | 3.00 | CO₂ | Ethanol | TA-15 | 68 | 125 | — | Rod |
| | | (2.66) | (1.10) | | | | | |
| 18 | 4.00 | CO₂ | Ethanol | TA-15 | 70 | 100 | — | Rod |
| | | (2.66) | (1.10) | | | | | |
| 19 | 4.00 | CO₂ | Ethanol | TA-15 | 70 | 90 | — | Rod |
| | | (3.60) | (1.10) | | | | | |
| 20 | 4.00 | CO₂ | Ethanol | TA-15 | 70 | 80 | — | Rod |
| | | (4.40) | (1.10) | | | | | |
| 21 | 4.00 | CO₂ | Ethanol | TA-15 | 79 | 90 | — | Rod |
| | | (3.30) | (0.83) | | | | | |
| 22 | 4.00 | CO₂ | Ethanol | TA-15 | 79 | 90 | — | Rod |
| | | (4.63) | (1.12) | | | | | |
| 23 | 4.00 | CO₂ | Acetone | TA-15 | 47 | 90 | — | Rod |
| | | (2.65) | (2.65) | | | | | |
| 24 | 4.00 | CO₂ | Acetone | TA-15 | 51 | 90 | — | Rod |
| | | (2.65) | (2.65) | | | | | |
| 25 | 4.00 | CO₂ | Acetone | TA-15 | 54 | 90 | — | Rod |
| | | (3.97) | (1.32) | | | | | |
| 26 | 4.00 | CO₂ | Acetone | PEG-15 | 57 | 150 | — | Rod |
| | | (3.30) | (2.65) | | | | | |
| 27 | 4.00 | CO₂ | Acetone | TEC-15 | 51 | 115 | — | Rod |
| | | (2.65) | (2.65) | | | | | |
| 28 | 4.00 | CO₂ | Ethanol | TEC-15 | 49 | 90 | 15 | Rod |
| | | (2.65) | (2.65) | | | | | |
| 29 | 4.00 | CO₂ | Ethanol | TA-15 | 54 | 90 | — | Rod |
| | | (2.65) | (2.65) | | | | | |
| 30 | 5.00 | CO₂ | Ethanol | PEG-15 | 55 | 130 | — | Rod |
| | | (2.65) | (2.65) | | | | | |
| 31 | 6.00 | CO₂ | Ethanol | PEG-15 | 60 | 150 | — | Rod |
| | | (2.65) | (2.65) | | | | | |
| 32 | 4.00 | CO₂ | Ethanol | PEG-15 | 53 | 100 | 10 | Rod |
| | | (2.65) | (2.65) | | | | | |
| 33 | 3.00 | CO₂ | Ethanol | TA-15 | 43 | 70 | 14 | Rod |
| | | (2.65) | (2.65) | | | | | |
| 34 | 2.00 | CO₂ | Ethanol | TA-15 | 41 | 100 | 14 | Rod |
| | | (2.65) | (2.65) | | | | | |
| 35 | 1.00 | CO₂ | Ethanol | TA-15 | 39 | 115 | — | Rod |
| | | (2.65) | (2.65) | | | | | |
| 36 | 0.00 | CO₂ | Ethanol | TA-15 | 39 | 1000 | 18 | Rod |
| | | (2.64) | (2.65) | | | | | |
| 37 | 4.00 | CO₂ | Ethanol | TA-15-U | 47 | 90 | — | Rod |
| | | (2.65) | (2.65) | | | | | |
| 38 | 3.00 | CO₂ | Ethanol | TA-15-U | 46 | 90 | — | Rod |
| | | (2.65) | (2.65) | | | | | |
| 39 | 2.00 | CO₂ | Ethanol | TA-15-U | 48 | 140 | — | Rod |
| | | (2.65) | (2.65) | | | | | |
| 40 | 2.00 | CO₂ | Ethanol | TA-15-U | 42 | 100 | — | Rod |
| | | (2.65) | (2.65) | | | | | |
| 41 | 1.00 | CO₂ | Ethanol | TA-15-U | 42 | 300 | — | Rod |
| | | (2.65) | (2.65) | | | | | |
| 42 | 0.00 | CO₂ | Ethanol | TA-15-U | 39 | 500 | — | Rod |
| | | (2.65) | (2.65) | | | | | |
| 43 | 0.00 | CO₂ | Ethanol | TA-15-U | 39 | 1000 | — | Rod |
| | | (1.32) | (3.97) | | | | | |
| 44 | 4.00 | CO₂ | Ethanol | TA-15-U | 45 | 100 | — | Rod |
| | | (2.65) | (3.30) | | | | | |
| 45 | 4.00 | CO₂ | Ethanol | TA-15-NS | 44 | 90 | — | Rod |
| | | (2.65) | (2.65) | | | | | |
| 46 | 4.00 | CO₂ | Ethanol | TA-10/ | 46 | 110 | 18 | Rod |
| | | (2.65) | (2.65) | FA-3 | | | | |
| 47 | 4.00 | CO₂ | Ethanol | TA-15 | 190 | 250 | — | Annular |
| | | (2.65) | (2.65) | | | | | die |
| 48 | 4.00 | CO₂ | Ethanol | TA-15 | 130 | 250 | — | Annular |
| | | (2.65) | (2.65) | | | | | die |
| 49 | 4.00 | CO₂ | Ethanol | TA-15 | 108 | 150 | — | Annular |
| | | (3.30) | (2.65) | | | | | die |
| 50 | 4.00 | CO₂ | Ethanol | TA-15 | 88 | 100 | — | Annular |
| | | (3.97) | (2.65) | | | | | die |
| 51 | 2.00 | CO₂ | Ethanol | TA-15 | 85 | 100 | — | Annular |
| | | (3.97) | (2.65) | | | | | die |
| 52 | 6.00 | CO₂ | Ethanol | TA-15 | 78 | 90 | — | Annular |
| | | (3.97) | (2.65) | | | | | die |
| 53 | 4.00 | CO₂ | Ethanol | TA-10 | 43 | 60 | 14 | Rod |
| | | (2.65) | (2.65) | | | | | |
| 54 | 4.00 | CO₂ | Ethanol | PEG-10 | 54 | 175 | 16 | Rod |
| | | (2.65) | (2.65) | | | | | |
| 55 | 4.00 | CO₂ | Ethanol | PEG-10 | 55 | 175 | — | Rod |
| | | (3.30) | (3.30) | | | | | |
| 56 | 6.00 | CO₂ | Ethanol | PEG-10 | 55 | 250 | — | Rod |
| | | (3.30) | (3.30) | | | | | |
| 57 | 2.00 | CO₂ | Ethanol | PEG-10 | 52 | 400 | — | Rod |
| | | (3.30) | (3.30) | | | | | |
| 58 | 4.00 | CO₂ | Ethanol | PEG-10 | 54 | 400 | — | Rod |
| | | (2.65) | (3.97) | | | | | |
| 59 | 4.00 | CO₂ | Ethanol | TA-12.5 | 56 | 100 | 13 | Rod |
| | | (2.65) | (2.65) | | | | | |
| 60 | 4.00 | CO₂ | Isopropanol | TA-15 | 60 | 100 | — | Rod |
| | | (2.65) | (2.65) | | | | | |
| 61 | 4.00 | CO₂ | Ethyl | TA-15 | 61 | 90 | — | Rod |
| | | (2.65) | acetate | | | | | |
| | | | (2.65) | | | | | |
| 62 | 4.00 | CO₂ | Ethanol | TA-15 | 51 | 115 | — | Sheet |
| | | (2.65) | (2.65) | | | | | die |
| 63 | 4.00 | CO₂ | Ethanol | TA-15 | 55 | 90 | — | Sheet |
| | | (2.65) | (2.65) | | | | | die |

### Example 2

To further demonstrate various aspects and embodiments of the present invention, various foamable compositions and foams were formed as set forth in detail below.

### Materials and Abbreviations

Cellulose acetate CA: procured from Eastman Chemical Company (commercially available from Eastman as product CA-394-60S) with the following characteristics: (DS_{ac}=2.5; melt point=230-250° C.; T_{g} 188-192° C.). Samples were stabilized with 1 wt. % Vikoflex 7170 (Arkema).
Plasticizers (PZ): Triacetin (TA, Eastman, food grade) used at weight percents as indicated numerically in the “formulation” column of Table 3
Stabilizer: Vikoflex 7170 (Arkema)
Physical Nucleating Agent (PNA): Talc (ABT-1000)
Physical Blowing Agents (PBA): CO₂, propane, Isobutane, n-pentane, Iso-pentane, and water as indicated
Foam Formation: (all percentages are weight percent based on total composition weight)

CA, plasticizer, and stabilizer are combined in varying amounts as indicated below by mixing in a Leistritz 18 mm twin screw extruder and forming pellets. The resulting material were fed into a tandem extruder setup to make extruded foam sheets. The physical blowing agent and talc was mixed in the twin screw extruder (ZE 30) followed by transferring the melt to the single screw extruder (KE 60). An annular die was used to extrude the foam sheet tube before stretching and cutting the sheet open over a calibrator cylinder. Extrusion temperatures are set forth in Table 3 below. Extrusion of the resulting foamable compositions generated foam sheet samples with thickness between 1-5 mm.

Foam samples were then analyzed for density and average cell size, with density measured using an analytical balance where the sample was immersed in water and Archimedes principle was used to measure the volume displacement. Average cell sizes were measured using a Proscope USB Microscope M2, with M100 and M200 lens unit and using Proscope HR/HR2 software or using images develop using Scanning electron microscope (SEM). The density and cell size results are set forth in Table 3 below.

TABLE 3
COMPOSITIONS AND FOAMS

| | | | | | | | | | Melt temp | Melt temp | |
|---|---|---|---|---|---|---|---|---|---|---|---|
| | | | | | | | | | at the end | at the end | |
| | | Blowing | Blowing | Blowing | Talc | Average | | Pressure | of first | of second | Die |
| | | agent 1 | agent 2 | agent 3 | level | cell size | Density | at the | extruder | extruder | Temp |
| Sample # | Formulation | (wt %) | (wt %) | (wt %) | wt % | (micron) | (g/L) | die (bar) | ZE30 (° C.) | KE60 (° C.) | (° C.) |
| 64 | TA-15 | CO₂ | N/A | N/A | 0.75 | 200-500 | 123 | 53.00 | 226.00 | 210.00 | 195 |
| | | (1.10) | | | | | | | | | |
| 65 | TA-15 | CO₂ | N/A | N/A | 0.75 | 200-500 | 158 | 21.00 | 226.00 | 209.00 | 195 |
| | | (1.00) | | | | | | | | | |
| 66 | TA-15 | CO₂ | N/A | N/A | 0.75 | 300-500 | 152 | 80.00 | 227.00 | 210.00 | 195 |
| | | (1.00) | | | | | | | | | |
| 67 | TA-15 | CO₂ | N/A | N/A | 0.75 | 100-400 | 156 | 46.00 | 237.00 | 216.00 | 205 |
| | | (2.00) | | | | | | | | | |
| 68 | TA-15 | CO₂ | N/A | N/A | 0.75 | 100-400 | 166 | 65.00 | 245.00 | 216.00 | 205 |
| | | (1.10) | | | | | | | | | |
| 69 | TA-20 | CO₂ | N/A | N/A | 0.75 | 200-500 | 133 | 119.00 | 221.00 | 198.00 | 186 |
| | | (1.20) | | | | | | | | | |
| 70 | TA-20 | CO₂ | N/A | N/A | 0.75 | 100-400 | 187 | 44.00 | 220.00 | 200.00 | 192 |
| | | (1.00) | | | | | | | | | |
| 71 | TA-20 | Pentane | N/A | N/A | 0.75 | 300-400 | 622 | 46.00 | 206.00 | 195.00 | 190 |
| | | (1.05) | | | | | | | | | |
| 72 | TA-20 | Pentane | N/A | N/A | 0.75 | 300-400 | 453 | 38.00 | 206.00 | 195.00 | 190 |
| | | (1.97) | | | | | | | | | |
| 73 | TA-20 | CO₂ | N/A | N/A | 0.75 | 100-400 | 153 | 125.00 | 218.00 | 192.00 | 180 |
| | | (1.20) | | | | | | | | | |
| 74 | TA-20 | CO₂ | N/A | N/A | 0.75 | 200-500 | 163 | 85.00 | 220.00 | 189.00 | 180 |
| | | (1.50) | | | | | | | | | |
| 75 | TA-20 | CO₂ | N/A | N/A | 0.75 | 200-500 | 137 | 112.00 | 219.00 | 189.00 | 180 |
| | | (1.50) | | | | | | | | | |
| 76 | TA-20 | CO₂ | N/A | N/A | 0.75 | 200-500 | 99 | 113.00 | 219.00 | 189.00 | 180 |
| | | (1.75) | | | | | | | | | |
| 77 | TA-20 | CO₂ | N/A | N/A | 0.75 | 200-700 | 89 | 115 | 217 | 183.00 | 175 |
| | | (2.00) | | | | | | | | | |
| 78 | TA-20 | CO₂ | N/A | N/A | 0.75 | 200-400 | 89 | 94.00 | 218.00 | 184.00 | 175 |
| | | (3.00) | | | | | | | | | |
| 79 | TA-20 | Isobutane | N/A | N/A | 0.75 | 50-200 | 108 | 21.00 | 213.00 | 184.00 | 175 |
| | | (2.00) | | | | | | | | | |
| 80 | TA-20 | Isobutane | N/A | N/A | 0.75 | 50-100 | 69 | 19.00 | 215.00 | 184.00 | 175 |
| | | (3.00) | | | | | | | | | |
| 81 | TA-20 | Isobutane | N/A | N/A | 0.75 | 30-50 | 60 | 70.00 | 215.00 | 182.00 | 165 |
| | | (3.00) | | | | | | | | | |
| 82 | TA-20 | Propane | N/A | N/A | 0.75 | 30-50 | 64 | 83.00 | 214.00 | 189.00 | 180 |
| | | (3.00) | | | | | | | | | |
| 83 | TA-20 | Pentane | Propane | N/A | 0.75 | 50-100 | 73 | 100.00 | 216.00 | 184.00 | 175 |
| | | (5.00) | (2.00) | | | | | | | | |
| 84 | TA-20 | Water | N/A | N/A | 0.75 | >200 | >1000 | 55.00 | 216.00 | 188.00 | 175 |
| | | (2.00) | | | | | | | | | |
| 85 | TA-20 | Water | N/A | N/A | 1.50 | >200 | >1000 | 33.00 | 214.00 | 188.00 | 200 |
| | | (3.00) | | | | | | | | | |
| 86 | TA-20 | Isobutane | Ethanol | CO₂ | 0.75 | 200-400 | 77 | 86.00 | 216.00 | 179.00 | 200 |
| | | (1.01) | (1.01) | (0.432) | | | | | | | |
| 87 | TA-20 | Isobutane | CO₂ | N/A | 0.75 | 300-500 | 108 | 115.00 | 216.00 | 174.00 | 200 |
| | | (1.00) | (1.00) | | | | | | | | |
| 88 | TA-20 | Pentane | CO₂ | N/A | 0.75 | 200-1000 | 110 | 105.00 | 216.00 | 175.00 | 180 |
| | | (1.50) | (1.50) | | | | | | | | |
| 89 | TA-20 | Pentane | CO₂ | N/A | 0.75 | 200-1000 | 115 | 69.00 | 215.00 | 175.00 | 180 |
| | | (1.50) | (1.50) | | | | | | | | |
| 90 | TA-20 | Pentane | CO₂ | N/A | 0.75 | 200-1000 | 132 | 75 | 210 | 175.00 | 180 |
| | | (1.0) | (1.00) | | | | | | | | |
| 91 | TA-20 | Pentane | CO₂ | N/A | 0.75 | 500-1000 | 127 | 70.00 | 211.00 | 175.00 | 180 |
| | | (1.20) | (1.20) | | | | | | | | |
| 92 | TA-20 | Pentane | CO₂ | N/A | 0.75 | 400-500 | 115 | 86.00 | 215.00 | 175.00 | 180 |
| | | (1.50) | (1.50) | | | | | | | | |
| 93 | TA-20 | Pentane | N/A | N/A | 0.75 | 100-250 | 118 | 100.00 | 215.00 | 199.00 | 190 |
| | | (3.00) | | | | | | | | | |
| 94 | TA-20 | Pentane | N/A | N/A | 0.75 | 100-500 | 105 | 48.00 | 213.00 | 200.00 | 190 |
| | | (3.00) | | | | | | | | | |
| 95 | TA-20 | Butane | Pentane | N/A | 0.75 | 50-100 | 68 | 68.00 | 214.00 | 190.00 | 175 |
| | | (1.00) | (2.00) | | | | | | | | |

The invention claimed is:

1. A cellulose acetate foam, wherein the foam has a density of less than 0.20 g/cm³ and an average foam cell size of less than 200 micrometers.

2. The foam of claim 1 wherein said foam has a Rᵣₘₛ surface area roughness of from 0.01 to 500 microns.

3. The foam of claim 1, wherein the foam has a density of from 0.03 to 0.18 g/cm³.

4. The foam of claim 1, wherein the average foam cell size is from 30 micrometers to 180 micrometers.

5. The foam claim 1, wherein the foam further comprises 2 to 30 wt % of a processing aid based on the total weight of the foam.

6. The foam of claim 1, wherein the foam is prepared from a foamable composition, comprising (1) a cellulose acetate having a degree of substitution of acetyl(DS_{Ac}) in the range of from 1.8 to 2.6; (2) 2 to 30 wt % of processing aid; (3) 0.5 to 6.0 wt % of nucleating agent selected from the group consisting a physical nucleating agent and a chemical nucleating agent and combinations thereof; and (4) 1.5 to 10.0 wt % of physical blowing agent, wherein the proportions of each component of the composition is based on the total weight of the foamable composition.

7. The foam of claim 6, wherein the physical blowing agent is chosen from carbon dioxide, linear or branched (C₁₋₆)alkanol, CH₃COO(C₁₋₃)alkyl, linear or branched (C₃₋₆)alkane, ((C₁₋₃)alkyl)₂CO, or a combination thereof.

8. The foam of claim 5, wherein the processing aid in the foam or the foamable composition is a plasticizer selected from the group consisting of one or more of triacetin, triethyl citrate and polyethylene glycol having an average weight average molecular weight of from 200 to 1000 Da.

9. The foam of claim 6, wherein the nucleating agent is a physical nucleating agent having a median particle size of less than 2 microns.

10. The foam of claim 6, wherein the nucleating agent is a physical nucleating agent which is selected from the group consisting of talc, a magnesium silicate, a silicon dioxide, a magnesium oxide or combinations thereof.

11. The foam of claim 1, wherein the foam further comprises a biodegradable filler.

12. The foam of claim 11, wherein the biodegradable filler comprises hemp, agave, bagasse, bast, jute, flax, ramie, kenaf, sisal, bamboo, or wood cellulose fibers.

13. The foam of claim 11, wherein the biodegradable filler is a natural filler.

14. The foam of claim 1, wherein the foam or foamable composition comprises two or more cellulose acetates having different degrees of substitution of acetyl(DS_{Ac}).

15. The foam of claim 1, wherein the foam further comprises a biodegradable polymer which is chosen from a polyhydroxylalkanoate (“PHA”), a polylactic acid (“PLA”), a polycaprolactone (“PCL”), a polybutylene succinate (“PBS”), a polybutylene adipate terephthalate (“PBAT”), a cellulose mixed ester, a cellulose ether, a starch, a protein, or combinations thereof.

16. The foam of claim 15, wherein the biodegradable polymer is present at from 0.1 to 50 wt % based on the total weight of the foam or foamable composition.

17. An article comprising, prepared from or formed from the foam of claim 1.

18. The article of claim 17, wherein the foam or the article is one or more of compostable or disintegrable.

19. The article of claim 17, wherein the thickness of the foam or said article is less than 6 mm.

20. A method for forming a foam, the method comprising:
(a) forming a melt of a melt-processable composition, said melt-processable composition including (1) a cellulose acetate; (2) a processing aid; and (3) a nucleating agent;
(b) adding physical blowing agent to said melt to form a foamable melt; and
(c) thermally expanding said foamable melt under conditions sufficient to form a foam therefrom, wherein said wherein said conditions include a melt temperature of from 120° C. to 210° C. and a thermal expansion pressure of from 20 to 250 bar.
